(19) United States
(12) Patent Application Publication
(10) Pub. No.: US 2014/0111561 A1
(43) Pub. Date: Apr. 24, 2014

(54) LIQUID CRYSTAL DRIVE DEVICE AND LIQUID CRYSTAL DISPLAY DEVICE

(71) Applicant: SHARP KABUSHIKI KAISHA, Osaka-shi, Osaka (JP)

(72) Inventors: Yuichi Iyama, Osaka-shi (JP); Kazuhiko Tsuda, Osaka-shi (JP); Takao Imaoku, Osaka-shi (JP); Iori Aoyama, Osaka-shi (JP); Takatomo Yoshioka, Osaka-shi (JP)

(73) Assignee: SHARP KABUSHIKI KAISHA, Osaka-shi, Osaka (JP)

(21) Appl. No.: 14/126,458

(22) PCT Filed: May 31, 2012
(86) PCT No.: PCT/JP2012/064214

§ 371 Date: Dec. 16, 2013

(30) Foreign Application Priority Data
Jun. 27, 2011 (JP) 2011-142346

(51) Int. Cl. G09G 3/36

(52) U.S. Cl. CPC G09G 3/36
USPC 345/690

(57) ABSTRACT

The present invention provides a liquid crystal drive device and a liquid crystal display device each of which has a sufficiently excellent transmittance, provides a sufficiently high response speed, and sufficiently reduces the load on the circuit and the driver. The liquid crystal drive device of the present invention includes a first electrode pair that is a pair of electrodes and second electrode pair that is a pair of electrodes different from the first electrode pair. The device implements a driving operation that generates a potential difference between the electrodes of the first electrode pair and simultaneously generates a potential difference between the electrodes of the second electrode pair when a displayed image has a gray scale value that is half or smaller of the total number of gray scale values for image display.

### TECHNICAL FIELD

The present invention relates to a liquid crystal drive device and a liquid crystal display device. The present invention specifically relates to a liquid crystal drive device and a liquid crystal display device which can be suitably used for display devices requiring a high response speed, such as field-sequential liquid crystal display devices, onboard display devices, and 3D display devices (display devices capable of recognizing three-dimensional images).

### BACKGROUND ART

A liquid crystal drive device includes a pair of glass substrates and a liquid crystal layer disposed therebetween, and is widely used for controlling image display by driving the liquid crystal. For example, a liquid crystal display device equipped with such a liquid crystal drive device characteristically has a thin profile, a light weight, and a low power consumption, and is indispensable in everyday life and business as a display for devices including personal computers, televisions, onboard devices (e.g. automotive navigation systems), and personal digital assistants (e.g. mobile phones). In these applications, persons skilled in the art have studied liquid crystal drive devices of various modes with different electrode arrangements and different substrate designs for changing the optical characteristics of the liquid crystal layer.

Examples of the display modes of current liquid crystal display devices include: a vertical alignment (VA) mode in which liquid crystal molecules having negative anisotropy of dielectric constant are aligned vertically to the substrate surfaces; an in-plane switching (IPS) mode in which liquid crystal molecules having positive or negative anisotropy of dielectric constant are aligned horizontally to the substrate surfaces and a transverse electric field is applied to the liquid crystal layer; and a fringe field switching (FFS) mode.

One document discloses, as a FFS-driving liquid crystal display device, a thin-film-transistor liquid crystal display having a high response speed and a wide viewing angle. The device includes a first substrate having a first common electrode layer; a second substrate having a pixel electrode layer and a second common electrode layer; a liquid crystal disposed between the first substrate and the second substrate; and a means for generating an electric field between the first common electrode layer of the first substrate and both of the pixel electrode layer and the second common electrode layer of the second substrate so as to provide a high speed response to a fast input-data-transfer rate and a wide viewing angle for a viewer (for example, see Patent Literature 1).

Another document discloses, as a liquid crystal device with multiple electrodes applying a transverse electric field, a liquid crystal device including a pair of substrates opposite to each other; a liquid crystal layer which includes a liquid crystal having a positive anisotropy of dielectric constant and which is disposed between the substrates; electrodes which are provided to the respective first and second substrates constituting the pair of substrates, facing each other with the liquid crystal layer therebetween, and which apply a vertical electric field to the liquid crystal layer; and multiple electrodes for applying a transverse electric field to the liquid crystal layer disposed on the second substrate (for example, see Patent Literature 2).

### CITATION LIST

### Patent Literature

Patent Literature 1: JP 2006-523850 T
Patent Literature 2: JP 2002-365657 A

### SUMMARY OF INVENTION

### Technical Problem

Patent Literature 1 discloses a vertical alignment liquid crystal display device having three-layered electrode structure, which enables high-speed response by rotating the liquid crystal molecules by an electric field in both rising and falling. The rising (where the display state changes from a dark state (black display) to a bright state (white display)) utilizes a fringe electric field (FFS driving) generated between an upper slit and a lower planar electrode of the lower substrate. The falling (where the display state changes from a bright state (white display) to a dark state (black display)) utilizes a vertical electric field generated by a potential difference between the substrates.

FIG. 57 is a schematic cross-sectional view showing a liquid crystal drive device having a conventional FFS-driving electrode structure on the lower substrate. FIG. 58 is a schematic plan view showing the liquid crystal drive device shown in FIG. 57. FIG. 59 shows simulation results of director D distribution, electric field distribution, and transmittance distribution of the liquid crystal drive device shown in FIG. 57. FIG. 57 shows the structure of the liquid crystal drive device. A certain voltage is applied to a slit electrode (14 V in the figure; for example, the potential difference between each slit electrode and a counter electrode 813 is at least the threshold value; the “threshold value” herein means a voltage value that generates an electric field causing optical changes of the liquid crystal layer and changes in the display state of the liquid crystal display device). Common electrodes 813 and 823 are disposed on the substrate having the slit electrode and its opposite substrate, respectively. The counter electrodes 813 and 823 are each set to 7 V. FIG. 59 shows the simulation results in rising, which shows voltage distribution, director D distribution, and transmittance distribution (solid line).

As disclosed in Patent Literature 1, application of a fringe electric field by a slit electrode in a liquid crystal display device with vertically aligned liquid crystal molecules rotates only the liquid crystal molecules near the slit electrode edges (FIG. 59). This causes an insufficient transmittance.

In order to achieve a good transmittance, a pair of comb-shaped electrodes is used instead of the slit electrode 817 shown in FIG. 58 to implement comb driving, thereby sufficiently aligning the liquid crystal molecules between the comb-shaped electrodes in the horizontal direction.

In the case where the total number of gray scale values for image display is (from a gray scale value of 0 to a gray scale value of 255) and the liquid crystal molecules are driven from a gray scale value of 255 to a gray scale value of 0, for example, the liquid crystal molecules are usually naturally relaxed, and thus the response speed is slow. Here, application of a vertical electric field allows a positive liquid crystal (liquid crystal having positive anisotropy of dielectric constant) to align in the vertical direction, thereby increasing the response speed. It should be noted that the white state and the black state require different ways of applying a voltage. Thus, the driving method needs to be well considered for desired gray scale values in practice. Examples of the driving method include those disclosed in Japanese Patent Application No. 2011-061662 and Japanese Patent Application No. 2011-061663, such as a method in which the device is turned into the OFF state completely, and then a next gray scale value is written.

This method requires at least two driving operations for expressing one gray scale value. Thus, the response time is as long as the sum of the time for turning into the OFF state and the time for turning into the ON state (in the above patent documents, 0.8 msec (OFF time)+2.4 msec (ON time)). Further, the number of driving operations is more than double. As a result, the circuit and the driver suffer a heavier load.

In addition, the above method requires separated driving of the electrodes. For example, separated driving of the electrodes in comb driving with a three-layered electrode structure requires two TFTs on the upper electrode and one TFT on the lower electrode per subpixel. As the number of TFTs increases, the opening becomes narrower, and thus the aperture ratio and the transmittance may be low. In other words, each subpixel requires three TFTs and it fails to have a sufficiently excellent aperture ratio. A transverse electric field is applied for the ON state of the display, whereas a vertical electric field is applied for the OFF state of the display. That is, driving methods are different from each other and different ways of applying a voltage provide different performances of the halftone display. However, the aforementioned documents describe no such driving methods.

The present invention is devised in view of the above situation, and aims to provide a liquid crystal drive device and a liquid crystal display device having a sufficiently excellent transmittance, having a sufficiently high response speed, and capable of sufficiently reducing the load on the circuit and the driver in the liquid crystal drive device and the liquid crystal display device.

### Solution to Problem

The present inventors have performed studies on a liquid crystal drive device and a liquid crystal display device in which at least two pairs of electrodes drive the liquid crystal. As a result of the studies, they have found the following: that is, at least two pairs of electrodes suitably switch the state between two ON electric fields (switching from one electric-field-applied state to another electric-field-applied state) by driving the liquid crystal by at least two pairs of electrodes and further forming electric field states owing to a driving operation that generates a potential difference between the electrodes of a first electrode pair and to a driving operation that generates a potential difference between the electrodes of a second electrode pair. This allows the liquid crystal molecules to rotate owing to an electric field in the electric-field-applied states and allows the liquid crystal display device to have a high response speed.

The present inventors have further performed studies for giving a higher response speed to a liquid crystal drive device and a liquid crystal display device in which an electric field rotates the liquid crystal molecules in both the rising and the falling while suitably displaying images of respective gray scale values and for reducing the load on the circuit and the driver sufficiently, focusing on a decrease in the number of driving operations for expressing one gray scale value in the drive device. Then, the present inventors have found the following: that is, a driving operation that generates a potential difference between electrodes of the first electrode pair and simultaneously generates a potential difference between electrodes of the second electrode pair provides a higher response speed while suitably displaying images of respective gray scale values, and reduces the load on the circuit and the driver sufficiently. As a result, the inventors have arrived at the solutions of the above disadvantages and have completed the present invention. In other words, the present inventors have found the following. Writing of a new gray scale value in conventional techniques requires application of a voltage for turning the display into the OFF state and subsequent writing of a predetermined gray scale value. This process results in a low response speed. In contrast, driving with continuous application of a vertical electric field or combination of driving with a transverse electric field for high gray scale values and driving with a transverse electric field and a vertical electric field for low gray scale values can solve the above disadvantage and improve the response speed and the transmittance.

As mentioned above, the present invention relates to a liquid crystal drive device and a liquid crystal display device in which at least two pairs of electrodes drive the liquid crystal, which are characteristically capable of implementing a driving method that provides a high transmittance by a transverse electric field display, displays images having the respective gray scale values suitably, provides a high response speed, and reduces the load on the circuit and the driver. The present invention is differentiated from the inventions of the above documents in this respect. The present invention can further solve a markedly poor response speed in a low-temperature environment, and can have an excellent transmittance.

The present invention relates to a liquid crystal drive device and a liquid crystal display device in which at least two pairs of electrodes drive the liquid crystal, which are capable of providing a high response speed and a high transmittance by rotating the liquid crystal molecules using an electric field in both the rising and the falling and by applying a vertical electric field during at least part of the display period. The present invention is differentiated from the known techniques of the above Patent Literature 1 and Patent Literature 2 in this respect. Although the Patent Literature 1 and Patent Literature 2 show no specific driving method, conventional displaying of a halftone image has a disadvantage. The present inventors have found a novel driving method that can solve such a disadvantage and will now propose such a method.

The present inventors also propose a driving method using one TFT or two TFTs per subpixel because driving with the use of three TFTs per subpixel reduces the aperture ratio. The comb-electrode driving requires separated driving of three electrodes. Thus, the present inventors have found the following suitable measures (A) to (D): (A) integrating lower electrodes (iii) in one direction (e.g. gate-line direction) and driving the electrodes in each line to reduce the number of TFTs for the lower electrodes (iii); (B) electrically connecting a lower electrode (iii) and one of upper electrodes (i) and (ii) via a contact hole to drive one of the upper electrodes (i) and (ii) and the lower electrode (iii) simultaneously; (C) integrating the upper electrodes (ii) in one direction (e.g. gate-line direction) and driving the electrodes in each line to reduce one TFT per subpixel; and (D) combining the above measures to drive one of the upper electrode (i) and the lower electrode (iii) simultaneously and to drive only the lower electrode (iii) by a TFT. In the present description, the symbol (i) indicates one electrode of the comb-shaped electrodes on the upper layer of the lower substrate or its electric potential; the symbol (ii) indicates the other electrode of the comb-shaped electrodes on the upper layer of the lower substrate or its electric potential; the symbol (iii) indicates the planar electrode on the lower layer of the lower substrate or its electric potential; and the symbol (iv) indicates the planar electrode on the upper substrate or its electric potential.

One aspect of the present invention is a liquid crystal drive device including a first substrate, a second substrate, a liquid crystal layer disposed between the substrates, and at least two pairs of electrodes including a first electrode pair and a second electrode pair that is different from the first electrode pair, the at least two pairs of electrodes driving a liquid crystal, the liquid crystal drive device being configured to implement a driving operation that generates a potential difference between electrodes of the first electrode pair and simultaneously generates a potential difference between electrodes of a second electrode pair when a displayed image has a gray scale value that is half or smaller of the total number of gray scale values for image display.

The present invention relates to a liquid crystal drive device and a liquid crystal display device in which two pairs of electrodes drive the liquid crystal (e.g. a vertical-alignment liquid crystal display device having a three-layered electrode structure (upper electrodes of the lower substrate are preferably a pair of comb-shaped electrodes)). The devices characteristically provide a high response speed by rotating the liquid crystal molecules by an electric field in both the rising and the falling; here, the rising utilizes an electric field (e.g. a transverse electric field for a positive liquid crystal) generated by a potential difference between one pair of electrodes, and the falling utilizes an electric field (e.g. a vertical electric field for a positive liquid crystal) generated by a potential difference between the other pair of electrodes. The devices also characteristically provide a high transmittance by a transverse electric field of comb driving at least when a displayed image has a high gray scale value. The liquid crystal drive device of the present invention is preferably one in which two pairs of electrodes drive the liquid crystal. The “two pairs of electrodes” herein consist of a pair of electrodes consisting of two electrodes and the other pair of electrodes consisting of two electrodes which are different from the former two electrodes. In other words, the “two pairs of electrodes” consist of four electrodes.

The liquid crystal drive device of the present invention at least has a period during which a potential difference is generated between the electrodes of the first electrode pair and simultaneously a potential difference is generated between the electrodes of the second electrode pair when a displayed image has a gray scale value that is half or smaller of the total number of gray scale values for image display, and it is not limited to a mode in which a potential difference is generated between the electrodes of the first electrode pair and simultaneously a potential difference is generated between the electrodes of the second electrode pair in a continuous manner when a displayed image has a gray scale value that is half or smaller of the total number of gray scale values for image display. The above period is not particularly limited as long as the device provides the effects of the present invention, and is preferably substantially half or longer of the period during which a displayed image has a gray scale value that is half or smaller of the total number of gray scale values for image display. Preferably, a potential difference between the electrodes of the first electrode pair and a potential difference between the electrodes of the second electrode pair are simultaneously generated during at least the former half of a subframe, which is a drive cycle of displaying an image, by changing the liquid crystal. As will be mentioned later, driving that generates a potential difference between the electrodes of the first electrode pair during the former half of a subframe but generates no potential difference during the latter half thereof is basically implemented for all the gray scale values for image display.

More preferable examples of the driving operation which generates a potential difference between the electrodes of the first electrode pair and simultaneously generates a potential difference between the electrodes of the second electrode pair when a displayed image has a gray scale value that is half or smaller of the total number of gray scale values for image display include: (I) a driving operation that generates a potential difference between the electrodes of the first electrode pair and simultaneously generates a potential difference between the electrodes of the second electrode pair even when a displayed image has a gray scale value that is greater than half of the total number of gray scale values for image display; (II) a driving operation that generates a potential difference between the electrodes of the first electrode pair but simultaneously generates no potential difference between the electrodes of the second electrode pair when a displayed image has a gray scale value that is greater than half of the total number of gray scale values for image display; and (III) a driving operation that changes an electric potential of one electrode of the second electrode pair during a subframe, which is a drive cycle of changing the liquid crystal, to display an image. The respective driving operations will be described in detail below.

The liquid crystal drive device preferably implements a driving operation that generates a potential difference between the electrodes of the first electrode pair and simultaneously generates a potential difference between the electrodes of the second electrode pair when a displayed image has a gray scale value that is greater than half of the total number of gray scale values for image display. In other words, it preferably generates a potential difference between the electrodes of the first electrode pair and simultaneously generates a potential difference between the electrodes of the second electrode pair not only for displayed images having low gray scale values but also for displayed images having high gray scale values. The device may implement a driving operation that generates a relatively greater potential difference between the electrodes of the first electrode pair than between the electrodes of the second electrode pair. In contrast, the device may implement a driving operation that generates a relatively greater potential difference between the electrodes of the second electrode pair than between the electrodes of the first electrode pair, for example, in the case where one electrode of the second electrode pair (the lower electrode of the second substrate) is continuously set to 15 V. Either of these driving operations is suitably implemented. A more preferable liquid crystal drive device is one which continuously applies a vertical electric field as well as a transverse electric field in electric-field application (during image display).

The liquid crystal drive device also preferably implements a driving operation that generates a potential difference between the electrodes of the first electrode pair but simultaneously generates no potential difference between the electrodes of the second electrode pair when a displayed image has a gray scale value that is greater than half of the total number of gray scale values for image display. In other words, the device is preferably in a mode that generates a potential difference between the electrodes of the first electrode pair but simultaneously generates no potential difference between the electrodes of the second electrode pair when a displayed image has a high gray scale value. A more preferable liquid crystal drive device is one which applies a transverse electric field when an image is displayed and applies a vertical electric field as well as a transverse electric field only when a displayed image has a low gray scale value. In this case, one (standard electric potential) of the first electrode pair is preferably fixed to a certain voltage (for example, 0 V or 15 V, and the voltage is changed when an electric potential change is inverted).

The liquid crystal drive device preferably inverts the electric potential changes of both the electrodes of the first electrode pair and inverts the electric potential change of one electrode of the second electrode pair during each subframe that is a drive cycle of changing the liquid crystal to display an image.

The liquid crystal drive device also preferably changes the electric potential of one electrode of the second electrode pair during image display. Examples of such a mode include a mode in which the electric potential of one electrode of the second electrode pair is changed during a subframe that is a drive cycle of changing the liquid crystal to display an image, and a mode in which the electric potential of one electrode of the second electrode pair is changed between such subframes. Either of these modes is preferred. In the case of changing the electric potential of one electrode of the second electrode pair during a subframe that is a drive cycle of driving the liquid crystal to display an image, for example, the electric potential of one electrode of the second electrode pair is preferably changed so as to match the electric potential of the other electrode such that a vertical electric field is turned into the OFF state during the subframe. Such driving of turning a vertical electric field into the OFF state during a subframe is basically implemented for all the gray scale values. This makes it possible to apply the design pattern (B-1) in addition to the design pattern (A) and the design pattern (B-2). Each of the design patterns will be mentioned later. Further, driving of turning a vertical electric field into the OFF state may be implemented during a subframe when a displayed image has a gray scale value that is half or smaller of the total number of gray scale values for display. In this case, the design pattern (A) and the design pattern (B-2) to be mentioned later may be applied. In the case of changing the electric potential of one electrode of the second electrode pair between subframes, the presence of a vertical electric field may be switched frame by frame, or a vertical electric field is applied only when the gray scale value is changed and no vertical electric field is applied when the gray scale value is not changed.

Since the liquid crystal drive device of the present invention can provide a high response speed, it is preferably used in field sequential driving display devices, onboard display devices, and 3D display devices (display devices capable of recognizing a three-dimensional image). The liquid crystal drive device of the present invention can provide a high response speed suitable for field sequential driving, for example; it enables the duration of one subframe to be set to 2 msec or shorter. Thus, the device is particularly preferably used for a field sequential driving liquid crystal drive device.

Preferably, the liquid crystal drive device includes multiple pixels for display, and electrodes each of which corresponds to one electrode of the first electrode pair and/or electrodes each of which corresponds to the other electrode of the first electrode pair are electrically connected along a pixel line. This makes it possible to reduce the number of TFTs and to improve the aperture ratio. Particularly preferably, the electrodes each of which corresponds to one electrode of the first electrode pair and/or the electrodes each of which corresponds to the other electrode of the first electrode pair are connected along a gate bus line. At least one electrode of the first electrode pair is also preferably electrically connected to one of the second electrode pair. This also makes it possible to reduce the number of TFTs and to improve the aperture ratio.

The electrodes each of which corresponds to one of the first electrode pair and/or the electrodes each of which corresponds to the other of the first electrode pair preferably include a transparent conductor and a metal conductor electrically connected to the transparent conductor. This makes it possible to reduce the resistance of the electrode and to sufficiently suppress rounding of the waveform. Although large-size panels have high-resistant electrodes and thus may disadvantageously show a rounded waveform, this mode can prevent such rounding. Thus, this mode is particularly preferably applied to large-size liquid crystal display devices.

Preferably, the liquid crystal drive device includes multiple pixels for display, and electrodes each of which corresponds to one electrode of the second electrode pair and/or electrodes each of which corresponds to the other electrode of the second electrode pair are electrically connected along a pixel line. This also makes it possible to reduce the number of TFTs and to improve the aperture ratio. Particularly preferably, the electrodes each of which corresponds to one electrode of the second electrode pair and/or the electrodes each of which corresponds to the other electrode of the second electrode pair are connected along a gate bus line.

The electrodes each of which corresponds to one of the second electrode pair and/or the electrodes each of which corresponds to the other of the second electrode pair preferably includes a transparent conductor and a metal conductor electrically connected to the transparent conductor. This makes it possible to reduce the resistance of the electrode and to sufficiently suppress rounding of the waveform. Similar to the aforementioned case, such a liquid crystal drive device is particularly preferably applied to large-size liquid crystal display devices.

The phrase “electrodes are electrically connected along a pixel line” herein means that electrodes are electrically connected at least in a single pixel line. For example, electrodes may be connected in each pixel line, or electrodes may be connected in each group of n pixel lines (in each group of n lines). Either is preferred. Here, n is an integer of 2 or greater. The phrase “electrodes are connected in each group of multiple (n) pixel lines” herein at least means that electrodes in multiple pixel lines are electrically connected. Examples thereof include a mode in which electrodes are electrically connected in each odd-numbered pixel line or in each even-numbered pixel line. In the case where electrodes are connected in each group of multiple pixel lines, the electric potentials of the multiple lines are usually inverted at the same time.

The first electrode pair (preferably, a pair of comb-shaped electrodes) preferably satisfies that two comb-shaped electrodes are disposed opposite to each other in a plan view of the main faces of the substrates. This pair of comb-shaped electrodes suitably generates a transverse electric field therebetween. With a liquid crystal layer including liquid crystal molecules having positive anisotropy of dielectric constant, the response performance and the transmittance are excellent in rising. With a liquid crystal layer including liquid crystal molecules having negative anisotropy of dielectric constant, the liquid crystal molecules are rotated by a transverse electric field to provide a high response speed in falling. The second electrode pair (preferably an electrode of the first substrate and an electrode of the second substrate) preferably provides a potential difference between the substrates. This generates a vertical electric field by the potential difference between the substrates in falling with a liquid crystal layer including liquid crystal molecules having positive anisotropy of dielectric constant and in rising with a liquid crystal layer including liquid crystal molecules having negative anisotropy of dielectric constant, and rotates the liquid crystal molecules by the electric field to provide a high response speed.

The pair of comb-shaped electrodes may be disposed on the same layer or may be disposed on different layers as long as it provides the effects of the present invention. The pair of comb-shaped electrodes is preferably disposed on the same layer. The phrase “a pair of comb-shaped electrodes is disposed on the same layer” herein means that the comb-shaped electrodes are in contact with the same component (e.g. insulating layer, liquid crystal layer) on the liquid crystal layer side and/or the side opposite to the liquid crystal layer side.

The pair of comb-shaped electrodes preferably satisfies that the teeth portions are along each other in a plan view of the main faces of the substrates. Particularly preferably, the teeth portions of the pair of comb-shaped electrodes are substantially parallel with each other, in other words, each of the comb-shaped electrodes has multiple substantially parallel slits.

The liquid crystal layer preferably includes liquid crystal molecules which are aligned in the orthogonal direction to the main faces of the substrates when no voltage is applied. The phrase “aligned in the orthogonal direction to the main faces of the substrates” and its derivative forms herein at least satisfy the state regarded as being aligned in the orthogonal direction to the main faces in the technical field, including a mode of alignment in the substantially vertical direction. The liquid crystal molecules in the liquid crystal layer preferably substantially consist of liquid crystal molecules aligned in the orthogonal direction to the main faces of the substrates at a voltage less than a threshold voltage. The phrase “when no voltage is applied” and its derivative forms herein at least satisfy the state regarded as substantially no voltage application in the technical field. Such a vertical alignment liquid crystal display panel is advantageous to provide characteristics such as a wide viewing angle and a high contrast, and its application range is widened. Further, the display panel more sufficiently provides the effects of the present invention.

The pair of comb-shaped electrodes preferably has different electric potentials at a threshold voltage or higher. This means a voltage value that provides a transmittance of 5% with the transmittance in the bright state defined as 100%, for example. The phrase “have different electric potentials at a threshold voltage or higher” herein at least means that a driving operation that generates different electric potentials at a threshold voltage or higher can be implemented. This makes it possible to suitably control the electric field applied to the liquid crystal layer. The upper limit of each of the different electric potentials is preferably 20 V, for example. Examples of a structure for providing different electric potentials include a structure in which one comb-shaped electrode of the pair of comb-shaped electrodes is driven by a certain TFT while the other comb-shaped electrode is driven by another TFT or the other comb-shaped electrode communicates with the electrode disposed below the other comb-shaped electrode. This structure makes it possible to provide different electric potentials. The width of each tooth portion of the pair of comb-shaped electrodes is preferably 2 μm or greater, for example. The gap (also referred to as the space herein) between tooth portions is preferably 2 to 7 μm, for example.

The liquid crystal display panel is preferably arranged such that the liquid crystal molecules in the liquid crystal layer are aligned in the orthogonal direction to the main faces of the substrates by an electric field generated between the pair of comb-shaped electrodes or between the first substrate and the second substrate.

The second electrode pair is preferably capable of providing a potential difference between the substrates. This generates a vertical electric field by the potential difference between the substrates in falling with a liquid crystal layer including liquid crystal molecules having positive anisotropy of dielectric constant and in rising with a liquid crystal layer including liquid crystal molecules having negative anisotropy of dielectric constant, thereby rotating the liquid crystal molecules by the electric field to provide a high response speed. For example, in the falling, an electric field generated between the upper and lower substrates rotates the liquid crystal molecules in the liquid crystal layer in the orthogonal direction to the main faces of the substrates, thereby providing a high response speed. Particularly preferably, the first electrode pair is a pair of comb-shaped electrodes disposed on one of the upper and lower substrates and the second electrode pair is a pair of counter electrodes disposed on the respective upper and lower substrates (the first substrate and the second substrate). More preferably, the first electrode pair is a pair of comb-shaped electrodes disposed on the second substrate.

Preferably, the counter electrodes disposed on the upper and lower substrates are planar electrodes. This generates a vertical electric field more suitably. The term “planar electrode” herein includes a mode in which multiple electrode portions of multiple pixels are electrically connected. Preferable examples of such a mode of the planar electrode of the first substrate include a mode in which electrode portions of all the pixels are electrically connected and a mode in which electrode portions in a pixel line are electrically connected. The second substrate preferably further has a planar electrode. This makes it possible to suitably apply a vertical electric field to provide a high response speed. The planar electrode of the second substrate is usually formed such that it sandwiches an electrically resistant layer with a pair of comb-shaped electrodes. The electrically resistant layer is preferably an insulating layer. The “insulating layer” herein is at least regarded as an insulating layer in the technical field.

A particularly preferable mode is such that the electrode of the first substrate is a planar electrode and the second substrate has another planar electrode. This makes it possible to suitably generate a vertical electric field by a potential difference between the substrates in falling, thereby providing a high response speed. A particularly preferable mode for suitable application of a transverse electric field and a vertical electric field is such that the electrodes (upper electrodes) at the liquid crystal layer side of the second substrate constitute a pair of comb-shaped electrodes and the electrode (lower electrode) opposite to the liquid crystal layer side of the second substrate is a planar electrode. For example, the planar electrode of the second substrate may be disposed on the layer (the layer in the second substrate opposite to the liquid crystal layer) below the pair of comb-shaped electrodes of the second substrate with an insulating layer interposed therebetween. The planar electrode of the second substrate may be driven separately in each pixel unit, and is preferably constituted by electrode portions electrically connected in a pixel line. In the case where one of the pair of the comb-shaped electrodes is communicated with the planar electrode that is a lower electrode of the comb-shaped electrodes and the planar electrode is constituted by electrode portions electrically connected in a pixel line, the comb-shaped electrodes communicated with the planar electrode are also electrically connected in a pixel line. This mode is also one preferable mode of the present invention. The planar electrode of the second substrate is preferably planar at least at the portion overlapping the electrode of the first substrate in a plan view of the main faces of the substrates.

In the case where the second substrate is an active matrix substrate, the term “pixel line” herein means an array of pixels aligned along the gate bus line or the source bus line in the active matrix substrate in a plan view of the main faces of the substrates. More preferably, it is an array of pixels aligned along the gate bus line. As mentioned above, electric connection of electrode portions of a planar electrode of the first substrate and/or electrode portions of a planar electrode of the second substrate in a pixel line enables application of a voltage to the electrode portions so that the electric potential of pixels in each even-numbered gate bus line and that in each odd-numbered gate bus line are inverted, thereby suitably generating a vertical electric field to provide a high response speed.

The “planar electrode(s)” of the first substrate and/or the second substrate herein at least satisfies/satisfy the state regarded as having a planar shape in the technical field of the present invention, and may have an alignment-controlling structure such as a rib or a slit in a certain region or may have such an alignment-controlling structure at the center portion of a pixel in a plan view of the main faces of the substrates. Still, preferably, the planar electrode has substantially no alignment-controlling structure.

The liquid crystal molecules in the liquid crystal layer are usually aligned by an electric field generated between a pair of comb-shaped electrodes or between the first substrate and the second substrate so that it contains a component horizontal to the main faces of the substrates at a threshold voltage or higher. In particular, the liquid crystal molecules preferably include those aligned in the horizontal direction. The phrase “aligned in the horizontal direction” and its derivative forms herein at least satisfy the state regarded as being aligned in the horizontal direction in the technical field of the present invention. This further improves the transmittance. The liquid crystal molecules in the liquid crystal layer preferably substantially consist of liquid crystal molecules aligned in the horizontal direction to the main faces of the substrates at a threshold voltage or higher.

The liquid crystal layer preferably includes liquid crystal molecules having positive anisotropy of dielectric constant (positive liquid crystal molecules). The liquid crystal molecules having positive anisotropy of dielectric constant are aligned in a certain direction when an electric field is applied. The alignment thereof is easily controlled and such molecules provide a higher response speed. The liquid crystal layer may also preferably include liquid crystal molecules having negative anisotropy of dielectric constant (negative liquid crystal molecules). This further improves the transmittance. From the viewpoint of a high response speed, the liquid crystal molecules preferably substantially consist of liquid crystal molecules having positive anisotropy of dielectric constant. From the viewpoint of transmittance, the liquid crystal molecules preferably substantially consist of liquid crystal molecules having negative anisotropy of dielectric constant.

At least one of the first substrate and the second substrate usually has an alignment film on the liquid crystal layer side. The alignment film is preferably a vertical alignment film. Examples of the alignment film include alignment films formed from organic material or inorganic material, and photo-alignment films formed from photoactive material. The alignment film may be an alignment film without any alignment treatment such as rubbing. Alignment films formed from organic or inorganic material and photo-alignment films each requiring no alignment treatment enable simplification of the process to reduce the cost, as well as improvement in the reliability and the yield. If an alignment film is rubbed, the rubbing may cause disadvantages such as liquid crystal contamination due to impurities from rubbing cloth, dot defects due to contaminants, and uneven display due to uneven rubbing in each liquid crystal panel. On the contrary, the present invention can eliminate these disadvantages. At least one of the first substrate and the second substrate preferably has a polarizing plate on the side opposite to the liquid crystal layer. The polarizing plate is preferably a circularly polarizing plate. This makes it possible to further improve the transmittance. The polarizing plate may also preferably be a linearly polarizing plate. This makes it possible to give excellent viewing angle characteristics. Such a liquid crystal display device having a polarizing plate shows an image by driving the liquid crystal, and thus is also referred to as a liquid crystal drive device herein.

The liquid crystal drive device of the present invention generates a vertical electric field, in other words, generates a potential difference at least between the electrode of the first substrate and an electrode (e.g. a planar electrode) of the second substrate by a driving operation that generates a potential difference between the electrodes of the second electrode pair. A preferable mode thereof is such that a higher potential difference is generated between the electrode of the first substrate and an electrode of the second substrate than that between electrodes (e.g. a pair of comb-shaped electrodes) of the second substrate.

The liquid crystal drive device of the present invention may implement a driving operation (also referred to as an initialization step herein) that generates no potential difference between the electric potential of the planar electrode of the first substrate and the electric potential of the planar electrode of the second substrate and generates no potential difference between the pair of comb-shaped electrodes of the second substrate as long as the liquid crystal drive device can provide the effects of the present invention. Still, the drive device preferably excludes such an initialization step. The initialization step can sufficiently reduce the transmittance, which slightly rises when the electric potentials of all the electrodes are not uniform, into an initial black state (for example, the portion defined by a dot line in FIG. 8). Here, application of a vertical electric field during image display as performed in the present invention also reduces the transmittance into the black state to an applicable level for image display. In other words, the liquid crystal drive device preferably implements no initialization step during each subframe in order to shorten the response time and prevent a greater load on the circuit and the driver.

The liquid crystal drive device of the present invention usually generates a transverse electric field by a driving operation that generates a potential difference between the electrodes of the first electrode pair. When a transverse electric field is generated, a potential difference is usually generated between electrodes (e.g. a pair of comb-shaped electrodes) of the second substrate. For example, the device may be in a mode such that a higher potential difference is generated between electrodes of the second substrate than that between the electrode of the first substrate and an electrode (e.g. planar electrode) of the second substrate. For halftone-image display, the device may be in a mode such that a lower potential difference is generated between electrodes of the second substrate than that between the electrode of the first substrate and an electrode of the second substrate. For image display at low gray scale values by a transverse electric field between the comb-shaped electrodes, for example, the electric potential of the planar electrode of the first substrate and the electric potential of the planar electrode of the second substrate may be set to 7.5 V and 0 V, respectively, and the electric potentials of the pair of comb-shaped electrodes of the second substrate may be set to 10 V and 5 V, respectively (electric potential difference between comb-shaped electrodes: 5 V).

Here, the commonly connected lower electrodes (the planar electrode of the second substrate) corresponding to even-numbered gate-bus lines and the commonly connected lower electrodes (the planar electrode of the second substrate) corresponding to odd-numbered gate-bus lines may be formed, and the electric potential changes thereof may be inverted in response to application of a voltage to these lower electrodes. The electric potential of an electrode maintained at a certain voltage may be defined as a middle electric potential. Assuming that this electric potential of an electrode maintained at this certain voltage is 0 V, the polarity of the voltage applied to the lower electrodes is considered to be inverted in each bus line.

The first substrate and the second substrate of the liquid crystal display panel of the present invention constitute a pair of substrates sandwiching the liquid crystal layer. They each may have an insulation substrate (e.g. glass, resin) as its base material, and the substrates are formed by disposing lines, electrodes, color filters, and the like on the insulation substrate.

Preferably, at least one of the pair of comb-shaped electrodes is a pixel electrode and the second substrate having the pair of comb-shaped electrodes is an active matrix substrate. The liquid crystal display panel of the present invention may be of a transmission type, a reflection type, or a transflective type.

The present invention also relates to a liquid crystal display device including the liquid crystal drive device of the present invention. Preferable modes of the liquid crystal drive device in the liquid crystal display device of the present invention are the same as the aforementioned preferable modes of the liquid crystal drive device of the present invention. Examples of the liquid crystal display device include displays of personal computers, televisions, onboard devices such as automotive navigation systems, and personal digital assistants such as mobile phones. Particularly preferably, the liquid crystal display device is applied to devices used at low-temperature conditions, such as onboard devices including automotive navigation systems.

The liquid crystal drive device of the present invention provides a high response speed, and thus can be suitably applied to display devices implementing field sequential driving, such as onboard display devices and 3D display devices. The field sequential driving repeats an operation of sequentially emitting light from multiple color light sources. One subpixel region expresses various hues without a color filter by turning the subpixel (liquid crystal layer) into a transmission state at the timing when a light source emits light and utilizing additive color mixture. Although the field sequential driving may deteriorate the display quality due to quick switching of images, use of a liquid crystal drive device with a high response speed, such as the liquid crystal drive device of the present invention, provides sufficiently excellent display quality.

Another aspect of the present invention is a liquid crystal drive device including a first substrate, a second substrate, a liquid crystal layer disposed therebetween, and at least two pairs of electrodes including a first electrode pair and a second electrode pair that is different from the first electrode pair, the at least two pairs of electrodes driving the liquid crystal. The liquid crystal drive device is configured to implement a driving operation that generates no potential difference between the electrodes of the first electrode pair but generates a potential difference between each electrode of the first electrode pair and one electrode of the second electrode pair, and simultaneously generates a potential difference between the electrodes of the second electrode pair when a displayed image has a gray scale value that is half or smaller of the total number of gray scale values for image display. This liquid crystal drive device allows the at least two pairs of electrodes to drive the liquid crystal, and generates a fringe electric field by generating no potential difference between the electrodes of the first electrode pair but generating a potential difference between the electrodes of the first electrode pair and one electrode of the second electrode pair when an image is displayed at a low gray scale value. At the same time of generating such a fringe electric field, a potential difference is also generated between the electrodes of the second electrode pair. Such a liquid crystal drive device can also exert the effects of the present invention as will be mentioned later. Preferable modes of the liquid crystal drive device in this aspect of the present invention are the same as preferable modes of the liquid crystal drive device in the aforementioned aspect of the present invention, as long as the modes can provide the effects of the present invention.

Another aspect of the present invention is a liquid crystal driving method in which a liquid crystal layer is sandwiched between a first substrate and a second substrate, and the liquid crystal is driven by at least two pairs of electrodes including a first electrode pair and a second electrode pair that is different from the first electrode pair. The liquid crystal driving method includes implementing a driving operation that generates a potential difference between the electrodes of the first electrode pair and simultaneously generates a potential difference between the electrodes of the second electrode pair when a displayed image has a gray scale value that is half or smaller of the total number of gray scale values for image display. Preferable modes of the liquid crystal driving method of the present invention are the same as preferable modes of the liquid crystal drive device of the present invention.

The configurations of the liquid crystal drive device and the liquid crystal display device of the present invention are not especially limited by other components as long as they essentially include such components, and other configurations usually used in liquid crystal drive devices and liquid crystal display devices may appropriately be applied.

The aforementioned modes may be employed in appropriate combination as long as the combination is not beyond the spirit of the present invention.

### Advantageous Effects of Invention

The liquid crystal drive device and the liquid crystal display device of the present invention can provide an excellent transmittance and a sufficiently high response speed, and can sufficiently reduce the load on the circuit and the driver.

### BRIEF DESCRIPTION OF THE DRAWINGS

FIG. 1 is a schematic cross-sectional view showing a liquid crystal drive device of Reference Example 1 in the presence of a transverse electric field.

FIG. 2 is a schematic cross-sectional view showing the liquid crystal drive device of Reference Example 1 in the presence of a vertical electric field.

FIG. 3 is a schematic cross-sectional view showing the liquid crystal drive device of Reference Example 1 in the presence of a transverse electric field.

FIG. 4 shows simulation results relating to the liquid crystal drive device shown in FIG. 3.

FIG. 5 is a schematic cross-sectional view showing the liquid crystal drive device of Reference Example 1 in the presence of a vertical electric field.

FIG. 6 shows simulation results relating to the liquid crystal drive device shown in FIG. 5.

FIG. 7 is a graph showing the comparison between the response waveforms in the simulations of comb driving and FFS driving.

FIG. 8 is a graph showing the measured drive response waveform and the rectangular waves applied to the respective electrodes in Reference Example 1.

FIG. 9 is a schematic cross-sectional view showing a liquid crystal drive device in the presence of a transverse electric field according to a driving method of Reference Example 2.

FIG. 10 is a schematic cross-sectional view showing the liquid crystal drive device in the presence of a vertical electric field according to the driving method of Reference Example 2.

FIG. 11 is a graph showing rectangular waves (drive waveforms) applied to the respective electrodes in the driving method of Reference Example 2.

FIG. 12 is a schematic cross-sectional view showing a liquid crystal display panel of Reference Example 3 in the presence of a transverse electric field.

FIG. 13 is a schematic cross-sectional view showing the liquid crystal display panel of Reference Example 3 in the presence of a vertical electric field.

FIG. 14 is a graph showing rectangular waves (drive waveforms) applied to the respective electrodes in Reference Example 3.

FIG. 15 is a graph showing the measured drive response waveforms in Reference Examples 1 to 3.

FIG. 16 is a graph showing electric potential changes of the respective electrodes with the initialization step implemented.

FIG. 17 is a graph showing electric potential changes of the respective electrodes of Embodiment 1 when the gray scale value of a displayed image is changed from 255 to 0.

FIG. 18 is a schematic cross-sectional view showing a liquid crystal drive device of Embodiment 1 when a displayed image has a gray scale value of 255.

FIG. 19 is a schematic cross-sectional view showing the liquid crystal drive device of Embodiment 1 when a displayed image has a gray scale value of 0.

FIG. 20 is a graph showing electric potential changes of the respective electrodes of Embodiment 1 when a halftone image is displayed.

FIG. 21 is a schematic cross-sectional view showing the liquid crystal drive device of Embodiment 1 when a halftone image is displayed.

FIG. 22 is a schematic cross-sectional view showing the liquid crystal drive device of Embodiment 1 when a halftone (reverse polarity) image is displayed.

FIG. 23 is a graph showing electric potential changes of the respective electrodes of Embodiment 2 when the gray scale level of a displayed image is changed from a high gray scale value to a low gray scale value (reverse potential).

FIG. 24 is a schematic cross-sectional view showing the liquid crystal drive device of Embodiment 2 when a displayed image has a high gray scale value.

FIG. 25 is a schematic cross-sectional view showing the liquid crystal drive device of Embodiment 2 when a displayed image has a low gray scale value (reverse potential).

FIG. 26 is a graph showing electric potential changes of the respective electrodes of Embodiment 2 when the gray scale level of a displayed image is changed from a low gray scale value to a high gray scale value (reverse potential).

FIG. 27 is a schematic cross-sectional view showing the liquid crystal drive device of Embodiment 2 when a displayed image has a low gray scale value.

FIG. 28 is a schematic cross-sectional view showing the liquid crystal drive device of Embodiment 2 when a displayed image has a high gray scale value (reverse potential).

FIG. 29 is a graph showing electric potential changes of the respective electrodes of Embodiment 3 when a halftone image is displayed.

FIG. 30 is a schematic cross-sectional view showing the liquid crystal drive device of Embodiment 3 when a halftone image is displayed.

FIG. 31 is a schematic cross-sectional view showing the liquid crystal drive device of Embodiment 3 when a halftone image is displayed (reverse potential).

FIG. 32 is a graph showing electric potential changes of the respective electrodes in one modified example of Embodiment 3 when an image is displayed.

FIG. 33 is a graph showing electric potential changes of the respective electrodes in the other modified example of Embodiment 3 when an image is displayed.

FIG. 34 is a graph showing electric potential changes of the respective electrodes of Embodiment 4 when the gray scale value of a displayed image is changed from a high gray scale value to a low gray scale value (reverse potential).

FIG. 35 is a schematic cross-sectional view showing a liquid crystal drive device of Embodiment 4 when a displayed image has a high gray scale value.

FIG. 36 is a schematic cross-sectional view showing the liquid crystal drive device of Embodiment 4 when a displayed image has a low gray scale value (reverse potential).

FIG. 37 is a graph showing electric potential changes of the respective electrodes of Embodiment 4 when the gray scale value of a displayed image is changed from a low gray scale value to a high gray scale value (reverse potential).

FIG. 38 is a schematic cross-sectional view showing the liquid crystal drive device of Embodiment 4 when a displayed image has a low gray scale value.

FIG. 39 is a schematic cross-sectional view showing the liquid crystal drive device of Embodiment 4 when a displayed image has a high gray scale value (reverse potential).

FIG. 40 is a schematic plan view showing one mode of the design pattern of the drive device of the present invention.

FIG. 41 is a schematic plan view showing one mode of the design pattern of the drive device of the present invention.

FIG. 42 is a schematic plan view showing one mode of the design pattern of the drive device of the present invention.

FIG. 43 is a schematic plan view showing one mode of the design pattern of the drive device of the present invention.

FIG. 44 is a schematic plan view showing one mode of the design pattern of the drive device of the present invention.

FIG. 45 is a schematic plan view showing one mode of the design pattern of the drive device of the present invention.

FIG. 46 is a graph showing one mode of the voltage application method in the drive device of Embodiment 1.

FIG. 47 is a graph showing one mode of the voltage application method in the drive device of Embodiment 2.

FIG. 48 is a graph showing one mode of the voltage application method in the drive device of Embodiment 2.

FIG. 49 is a graph showing one mode of the voltage application method in the drive device of Embodiment 2.

FIG. 50 is a graph showing one mode of the voltage application method in the drive device of Embodiment 2.

FIG. 51 is a graph showing one mode of the voltage application method in the drive device of Embodiment 4.

FIG. 52 is a graph showing one mode of the voltage application method in the drive device of Embodiment 4.

FIG. 53 is a schematic cross-sectional view showing a usual liquid crystal drive device when a displayed image has a low gray scale value.

FIG. 54 is a schematic cross-sectional view showing the liquid crystal drive device of the present invention implementing vertical-electric-field driving when a displayed image has a low gray scale value.

FIG. 55 is a bar graph showing the response speed in low-gray-scale driving.

FIG. 56 is a graph showing the relationship between the vertical electric field and the transverse electric field.

FIG. 57 is a schematic cross-sectional view showing a liquid crystal drive device of Comparative Example 1 in the presence of a fringe electric field.

FIG. 58 is a schematic plan view showing the liquid crystal drive device shown in FIG. 57.

FIG. 59 shows simulation results relating to the liquid crystal drive device shown in FIG. 57.

FIG. 60 is a schematic cross-sectional view showing one example of a liquid crystal display device used in the liquid crystal driving method of the present embodiment.

FIG. 61 is a schematic plan view showing an active drive element and its vicinity used in the present embodiment.

FIG. 62 is a schematic cross-sectional view showing the active drive element and its vicinity used in the present embodiment.

### DESCRIPTION OF EMBODIMENTS

The present invention will be described in detail below in view of the following embodiments and drawings. The present invention is not limited to these embodiments. The term “pixel” herein also means a subpixel unless otherwise specified. The term “gray scale” herein means the number of scales of halftone. The term “low gray scale value” herein at least means that a displayed image has a gray scale value that is half or smaller of the total number of gray scale values for image display. In the case where the total number of gray scale values for image display is 256 from a gray scale value 0 to a gray scale value 255, for example, an image having a low gray scale value is at least an image having a gray scale value of 128 or smaller. The term “high gray scale value” herein at least means that a displayed image has a gray scale value that is greater than half of the total number of gray scale values for image display. In the case where the total number of gray scale values for image display is 256 from a gray scale value of 0 to a gray scale value of 255, for example, an image having a high gray scale value is at least an image having a gray scale value of greater than 128.

The term “subframe” herein means a period for displaying an image with one color using part or all of the subpixels when, for example, colors are sequentially displayed during one frame by field sequential (time-division) driving in comparison with the frame during which an image is displayed by all of the pixels (e.g. RGB-including pixels), and it means a period for the above display. The term “frame” herein means a subframe unless otherwise mentioned. With respect to the pair of substrates sandwiching the liquid crystal layer, the substrate on the display side is also referred to as an upper substrate and the substrate on the side opposite to the display side is also referred to as a lower substrate. With respect to the electrodes disposed on the substrate, the electrodes on the display side are also referred to as upper electrodes and the electrodes on the side opposite to the display side are also referred to as lower electrodes. The circuit substrate (second substrate) of the present embodiment is also referred to as a TFT substrate or an array substrate because it includes a thin film transistor element (TFT). In the present embodiment, the TFT is turned into the ON state and thereby a voltage is applied to at least one electrode (pixel electrode) of the pair of comb-shaped electrodes in both the rising (application of transverse electric field) and the falling (application of vertical electric field). In each embodiment, the components or parts having the same function are given the same reference number.

The liquid crystal drive device of the present invention is a liquid crystal drive device in which at least two pairs of electrodes drive the liquid crystal and which characteristically implements a driving operation that generates a potential difference between the electrodes of the first electrode pair and simultaneously generates a potential difference between the electrodes of the second electrode pair when a displayed image has a low gray scale value. First, the following will describe that a transverse electric field improves the transmittance in the liquid crystal drive device in which two pairs of electrodes drive the liquid crystal (Reference Examples 1 to 3). The liquid crystal drive devices of Reference Examples 1 to 3 provide an improved transmittance, a sufficiently high response speed, and a sufficiently reduced load on the circuit and the driver, and thereby achieve the effects of the present invention by implementing a driving operation that generates a potential difference between the electrodes of the first electrode pair and simultaneously generates a potential difference between the electrodes of the second electrode pair when a displayed image has a low gray scale value (Embodiments 1 to 4).

### Reference Example 1

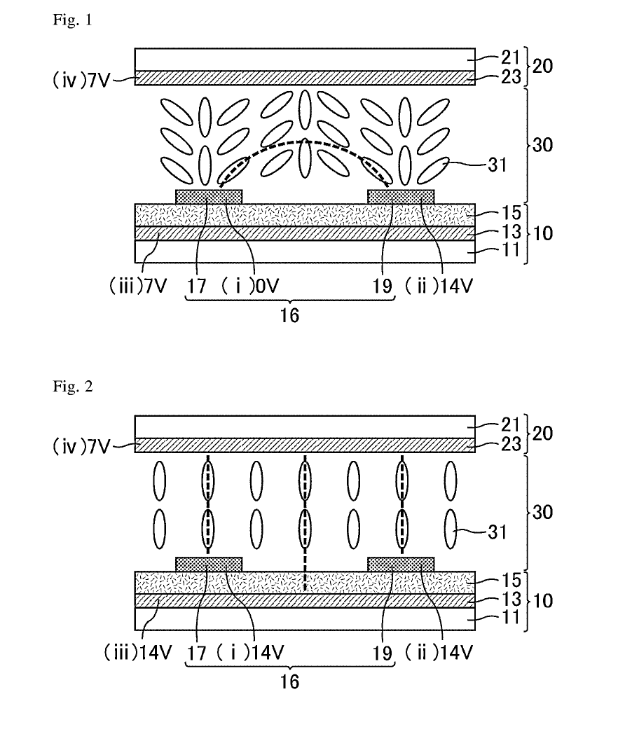

FIG. 1 is a schematic cross-sectional view showing the liquid crystal drive device of Reference Example 1 in the presence of a transverse electric field. FIG. 2 is a schematic cross-sectional view showing the liquid crystal drive device of Reference Example 1 in the presence of a vertical electric field. In each of FIG. 1 and FIG. 2, the dot line indicates the direction of an electric field generated. The liquid crystal drive device of Reference Example 1 has a vertical-alignment three-layered electrode structure (upper electrodes of the lower substrate, which serve as the second layer, are a pair of comb-shaped electrodes) using liquid crystal molecules 31 which are positive liquid crystal. In rising, as shown in FIG. 1, a transverse electric field generated by a potential difference of 14 V between a pair of comb-shaped electrodes 16 (for example, a comb-shaped electrode 17 at an electric potential of 0 V and a comb-shaped electrode 19 at an electric potential of 14 V) rotates the liquid crystal molecules. In this case, substantially no potential difference is generated between the substrates (between a counter electrode 13 at an electric potential of 7 V and a counter electrode 23 at an electric potential of 7 V).

In falling, as shown in FIG. 2, a vertical electric field generated by a potential difference of 7 V between the substrates (for example, between each of the counter electrode 13, the comb-shaped electrode 17, and the comb-shaped electrode 19 at an electric potential of 14 V and the counter electrode 23 at an electric potential of 7 V) rotates the liquid crystal molecules. In this case, substantially no potential difference is generated between the pair of comb-shaped electrodes 16 (for example, consisting of the comb-shaped electrode 17 at an electric potential of 14 V and the comb-shaped electrode 19 at an electric potential of 14 V).

In both the rising and the falling, an electric field rotates the liquid crystal molecules to provide a high response speed. In other words, the transverse electric field between the pair of comb-shaped electrodes leads to the ON state to give a high transmittance in the rising, whereas the vertical electric field between the substrates leads to the ON state to give a high response speed in the falling. Further, the transverse electric field by comb driving also provides a high transmittance. Reference Example 1 and the following embodiments use a positive liquid crystal as the liquid crystal. Still, a negative liquid crystal may also be used instead of the positive liquid crystal. In the case of a negative liquid crystal, a potential difference (vertical electric field) between the pair of substrates aligns the liquid crystal molecules in the horizontal direction and a potential difference (transverse electric field) between the pair of comb-shaped electrodes aligns the liquid crystal molecules in the vertical direction. This provides an excellent transmittance, and an electric field rotates the liquid crystal molecules to provide a high response speed in both the rising and the falling. In either of the positive liquid crystal or the negative liquid crystal, application of a vertical electric field in addition to a transverse electric field during at least one period of image display provides a high response speed, reduce the load on the circuit, and sufficiently reduce the transmittance at black display to the extent applicable to image display. The electric potentials of the pair of comb-shaped electrodes are indicated by the symbols (i) and (ii), the electric potential of the planar electrode of the lower substrate is indicated by the symbol (iii), and the electric potential of the planar electrode of the upper substrate is indicated by the symbol (iv).

As shown in FIG. 1 and FIG. 2, the liquid crystal drive device of Reference Example 1 includes an array substrate 10, a liquid crystal layer 30, and an opposed substrate 20 (color filter substrate) stacked in the order set forth from the back side to the viewing side of the liquid crystal drive device. As shown in FIG. 2, the liquid crystal drive device of Reference Example 1 vertically aligns the liquid crystal molecules at lower than the threshold voltage. As shown in FIG. 1, an electric field generated between the upper electrodes 17 and 19 (the pair of comb-shaped electrodes 16) disposed on the glass substrate 11 (second substrate) tilts the liquid crystal molecules in the horizontal direction between the comb-shaped electrodes when a voltage difference between the comb-shaped electrodes is not lower than the threshold voltage, thereby controlling the amount of light transmitted. The planar lower electrode 13 (counter electrode 13) is disposed such that it sandwiches an insulating layer 15 with the upper electrodes 17 and 19 (the pair of comb-shaped electrodes 16). The insulating layer 15 may be formed from an oxide film (e.g. SiO₂), a nitride film (e.g. SiN), or an acrylic resin, for example, and these materials may be used in combination.

Although not shown in FIG. 1 and FIG. 2, a polarizing plate is disposed on each substrate at the side opposite to the liquid crystal layer. The polarizing plate may be a circularly polarizing plate or may be a linearly polarizing plate. An alignment film is disposed on the liquid crystal layer side of each substrate. The alignment films each may be an organic alignment film or may be an inorganic alignment film as long as they align the liquid crystal molecules orthogonally to the film surface.

A voltage supplied from an image signal line (source bus line) is applied to the comb-shaped electrode 19, which drives the liquid crystal material, through a thin film transistor element (TFT) at the timing when a pixel is selected by a scanning signal line. The comb-shaped electrode 17 and the comb-shaped electrode 19 are formed on the same layer in the present embodiment and are preferably in a mode where they are formed on the same layer. Still, the comb-shaped electrodes may be formed on different layers as long as a voltage difference is generated between the comb-shaped electrodes to apply a transverse electric field and provides one effect of the present invention, that is, the effect of improving the transmittance. The comb-shaped electrode 19 is connected to a drain electrode that extends from the TFT through a contact hole. In FIG. 1 and FIG. 2, the counter electrodes 13 and 23 have a planar shape. The counter electrodes 13 corresponding to the even-numbered gate-bus lines are commonly connected, and the counter electrodes 13 corresponding to the odd-numbered gate-bus lines are commonly connected. Such a group of commonly connected electrodes is also referred to as a planar electrode herein. The counter electrodes 23 are commonly connected for all the pixels.

The electrode width L of each comb-shaped electrode in Reference Example 1 is 2.4 μm, and it is preferably 2 μm or greater, for example. The electrode gap S between the comb-shaped electrodes is 2.6 μm, and it is preferably 2 μm or greater, for example. The upper limit thereof is preferably 7 μm, for example.

The ratio (L/S) between the electrode gap S and the electrode width L is preferably 0.4 to 3, for example. The lower limit thereof is more preferably 0.5, whereas the upper limit thereof is more preferably 1.5.

The cell gap d is 5.4 μm. The cell gap is preferably 2 to 7 μm. The cell gap d (thickness of the liquid crystal layer) herein is preferably calculated by averaging the thicknesses throughout the liquid crystal layer in the liquid crystal drive device.

### (Verification of Response Performance and Transmittance by Simulation)

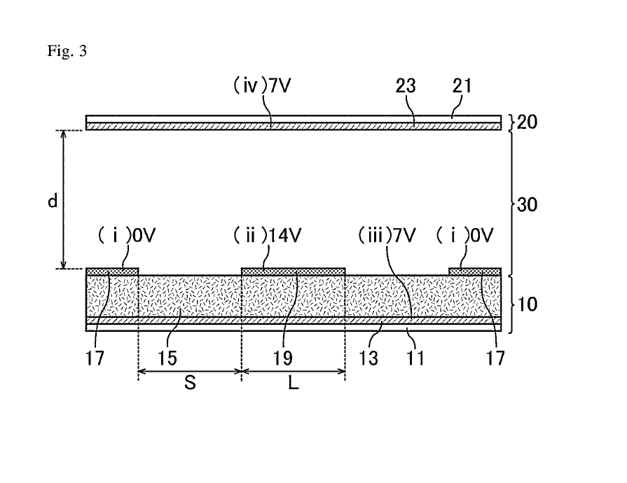

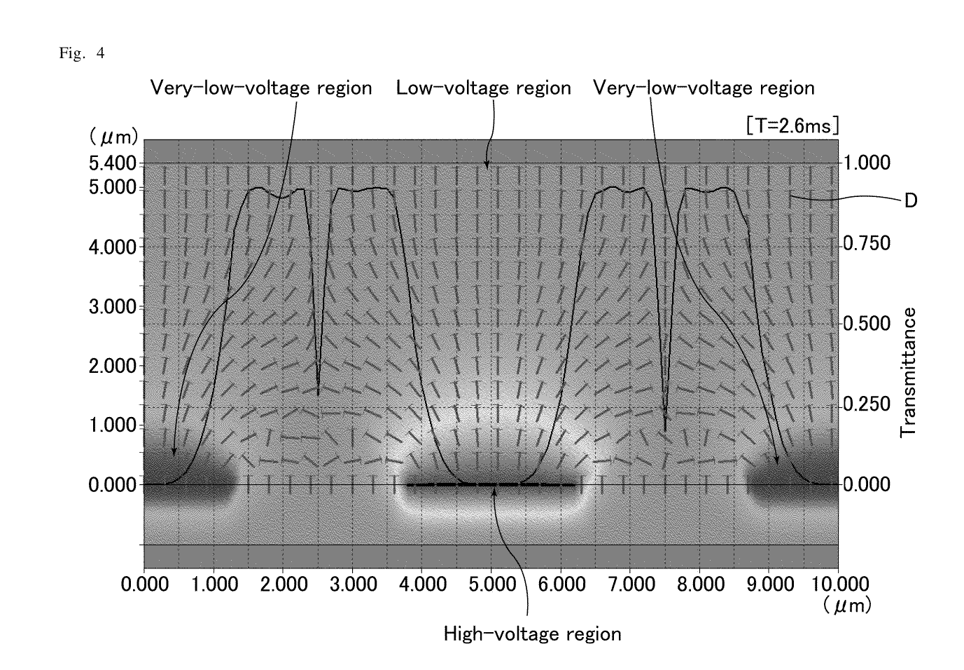

FIG. 3 is a schematic cross-sectional view showing the liquid crystal drive device of Reference Example 1 in the presence of a transverse electric field. The comb driving of Reference Example 1 generated a transverse electric field between the pair of comb-shaped electrodes 16 (e.g. the comb-shaped electrode 17 at an electric potential of 0 V and the comb-shaped electrode 19 at an electric potential of 14 V), and thereby rotated the liquid crystal molecules in a wide range between the pair of comb-shaped electrodes (FIG. 3, FIG. 4).

FIG. 4 shows simulation results relating to the liquid crystal drive device shown in FIG. 3. FIG. 4 shows the simulation results of director D, electric field, and transmittance distribution at the timing of 2.2 ms after the rising. The graph drawn by a solid line indicates the transmittance. The director D indicates the alignment direction of the major axis of the liquid crystal molecules. The simulation was performed with a cell thickness of 5.4 μm and a comb gap of 2.6 μm.

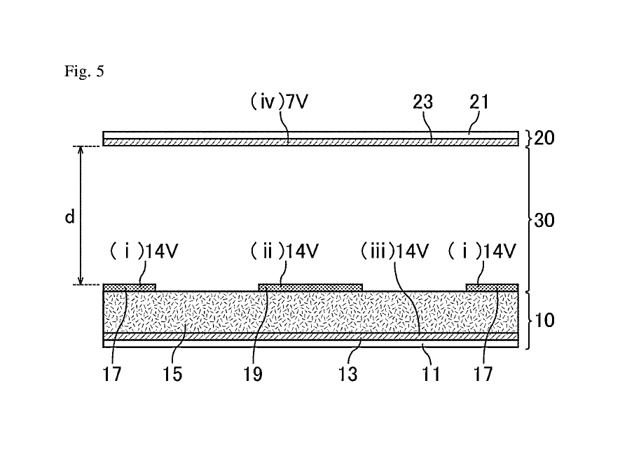

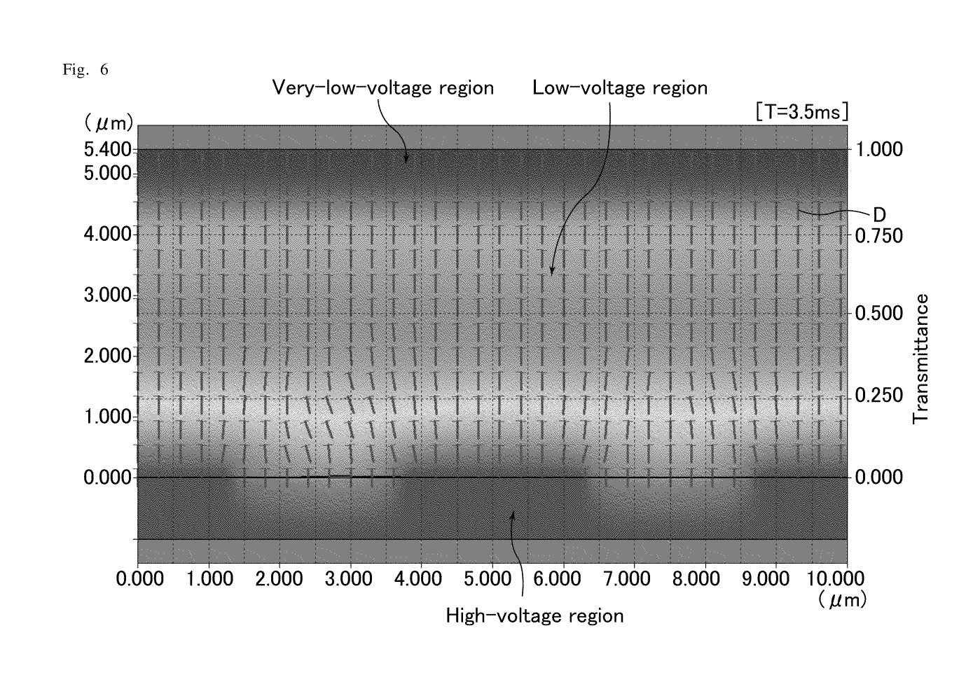

FIG. 5 is a schematic cross-sectional view showing the liquid crystal drive device of Reference Example 1 in the presence of a vertical electric field. A vertical electric field generated at a potential difference between the substrates of 7 V (e.g. between each of the counter electrode 13, the comb-shaped electrode 17, and the comb-shaped electrode 19 at an electric potential of 14 V and the counter electrode 23 at an electric potential of 7 V) rotates the liquid crystal molecules. FIG. 6 shows simulation results relating to the liquid crystal drive device shown in FIG. 5. FIG. 6 shows the simulation results of director D, electric field, and transmittance distribution at the timing of 3.5 ms that is after the end point (2.8 ms) of the rising period.

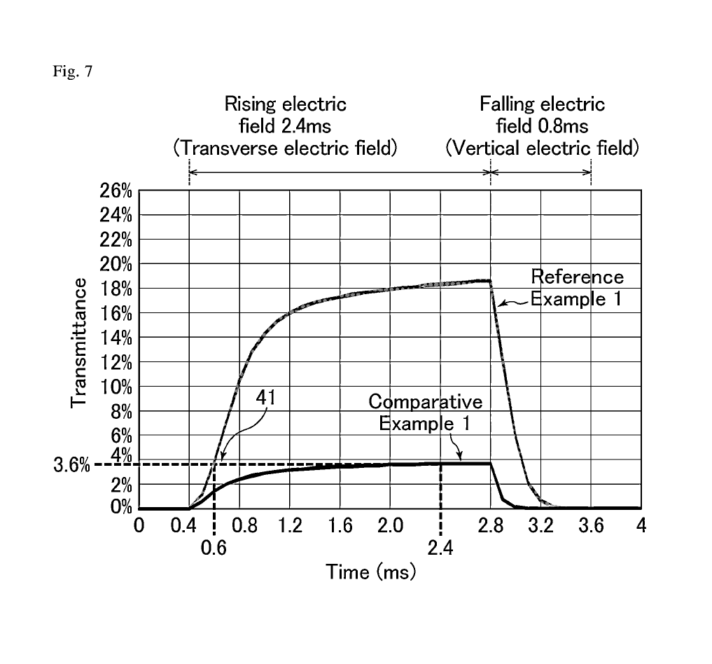

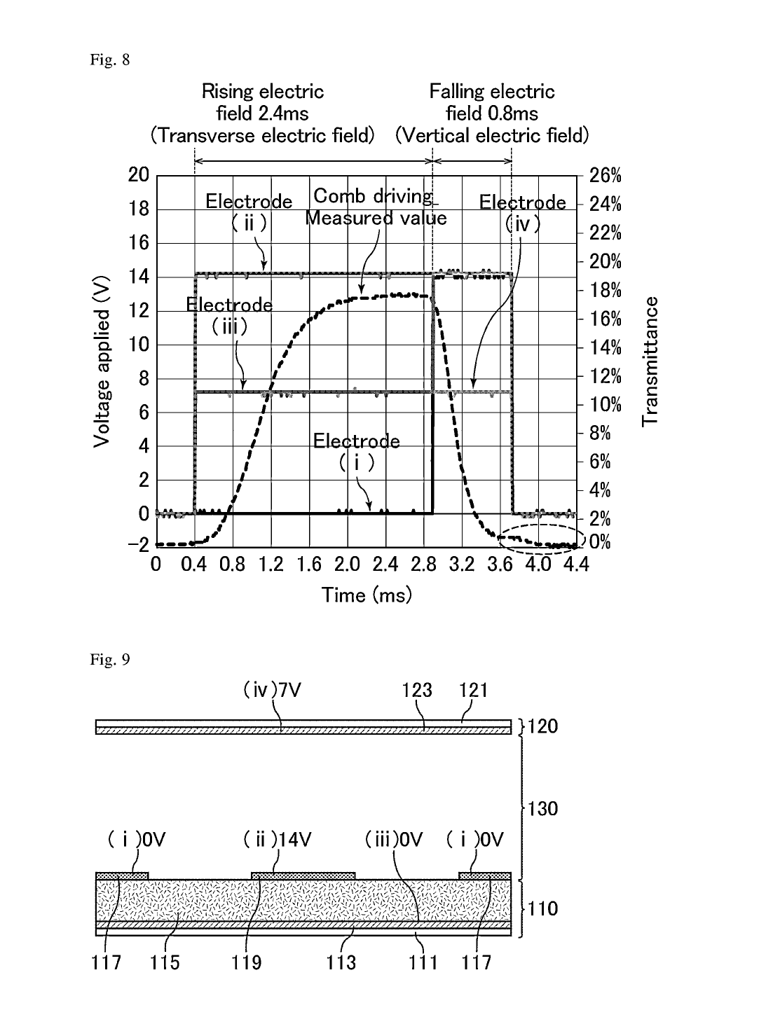

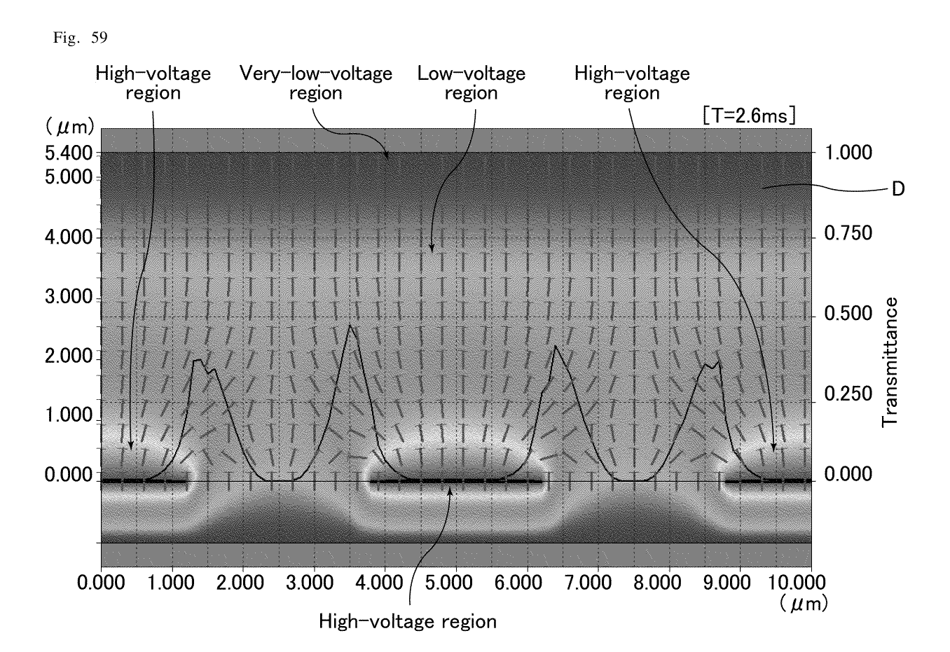

FIG. 7 is a graph showing the comparison between the response waveforms in the simulations of comb driving and FFS driving. The rising period (period of applying a transverse electric field) was 2.4 ms and the falling period (period of applying a vertical electric field) was 0.8 ms. No driving occurred in the first 0.4 ms. FIG. 7 compares the comb driving (Reference Example 1) and FFS driving (Comparative Example 1) to be mentioned later. A transverse electric field applied by the comb driving in the liquid crystal drive device of Reference Example 1 rotates the liquid crystal molecules in a wide range between the comb-shaped electrodes and provides a high transmittance (simulated transmittance: 18.6% (FIG. 7), measured transmittance (to be mentioned later): 17.7% (FIG. 8, for example)). In contrast, Comparative Example 1 (FFS driving in the prior art document) to be mentioned later failed to provide a sufficient transmittance. In the FFS driving of Comparative Example 1, a fringe electric field generated between the upper and lower electrodes of the lower substrate rotated the liquid crystal molecules. In this case, however, only the liquid crystal molecules near the slit electrode edges are rotated (FIG. 59), presumably having failed to provide a sufficient transmittance (simulated transmittance: 3.6% (FIG. 7)). The simulation was performed with a cell thickness of 5.4 μm and an electrode gap between the pair of comb-shaped electrodes of 2.6 μm.

The response speed may presumably be considered as follows. The transmittance (18.6%) provided by the comb driving in Reference Example 1 was higher than that (3.6%) achieved by the FFS driving in Comparative Example 1. Thus, the comb driving in Reference Example 1 provided a transmittance of 3.6% at a higher response speed than FFS driving by the use of overdrive. In other words, the response time in rising was shortened by applying a voltage at least higher than a rated voltage required for a transmittance of 3.6% by comb driving to cause rapid response of the liquid crystal, and then decreasing the voltage to the rated voltage at the timing when the transmittance reached a desired value. For example, in FIG. 7, the voltage was decreased to the rated voltage at a timing 41 (0.6 ms) to shorten the response time in rising. Falling from the same transmittance took the same response time.

### (Verification of Response Performance and Transmittance by Actual Measurement)

FIG. 8 is a graph showing the measured drive response waveform and the rectangular waves applied to the respective electrodes in Reference Example 1. Similar to the above simulation, the cell thickness was 5.4 μm and the electrode gap between the pair of comb-shaped electrodes was 2.6 μm. The measurement temperature was 25° C.

In the rising and the falling, as shown in FIG. 3 and FIG. 5, a voltage was applied to the electrodes and a transverse electric field and a vertical electric field, respectively, were applied to the liquid crystal molecules. In other words, the rising period was 2.4 ms of comb driving (Reference Example 1) between the pair of comb-shaped electrodes, whereas the falling period was 0.8 ms of vertical-electric-field driving between each of the pair of comb-shaped electrodes, the lower electrode of the lower substrate, and the counter electrode of the upper substrate (between each of the counter electrode 13, the comb-shaped electrode 17, and the comb-shaped electrode 19 and the counter electrode 23 in FIG. 2) (see the electrodes (i) to (iv) in FIG. 8 for the waveforms applied to the respective electrodes).

The actual measurement gave a maximum transmittance of 17.7% (simulated transmittance: 18.6%) in Reference Example 1, and thus a higher transmittance than in Comparative Example 1 (simulated transmittance: 3.6%) to be mentioned later was provided. In the rising, the response speed of 0.9 ms was provided at a transmittance of 10 to 90% (maximum transmittance was defined as 100%), whereas in the falling, the response speed of 0.4 ms was provided at a transmittance of 90 to 10% (maximum transmittance was defined as 100%). Thus, both the rising and the falling provided a higher response speed.

The reference numbers in the drawings relating to the reference examples, the embodiments, and the comparative examples are the same as those in the drawings relating to Reference Example 1 unless otherwise specifically mentioned, except that the hundreds digits are added.

### Reference Example 2

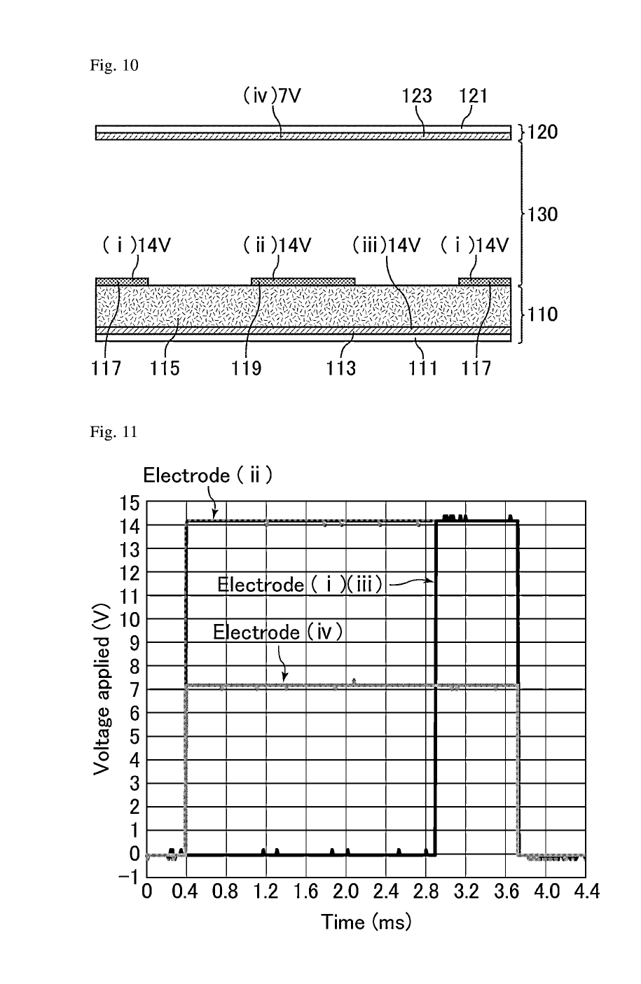

FIG. 9 is a schematic cross-sectional view showing the liquid crystal drive device in the presence of a transverse electric field according to the driving method of Reference Example 2. FIG. 10 is a schematic cross-sectional view showing the liquid crystal drive device in the presence of a vertical electric field according to the driving method of Reference Example 2. FIG. 11 is a graph showing the rectangular waves (drive waveforms) applied to the respective electrodes in the driving method of Reference Example 2.

In the driving method described in Reference Example 1, the counter electrode 13 and the counter electrode 23 were each applied a voltage (7 V) in-between the voltage difference (14 V) between the pair of comb-shaped electrodes in the presence of a transverse electric field. In Embodiment 2, a counter electrode 113 was set to the same electric potential as that of a comb-shaped electrode 117 which is one of the pair of comb-shaped electrodes and a counter electrode 123 was set to a voltage (7 V) in-between the voltage difference (14 V) between the pair of comb-shaped electrodes (Reference Example 2). The other conditions were the same as those in Reference Example 1.

### Reference Example 3

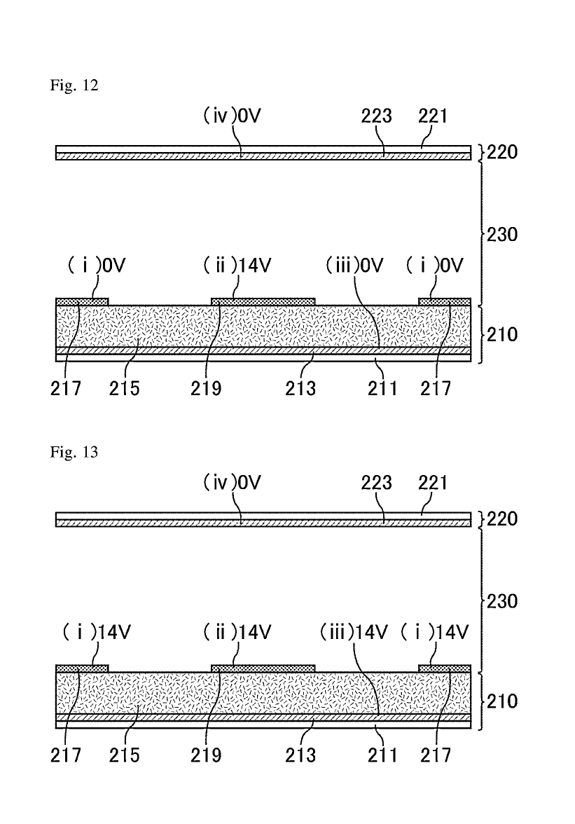

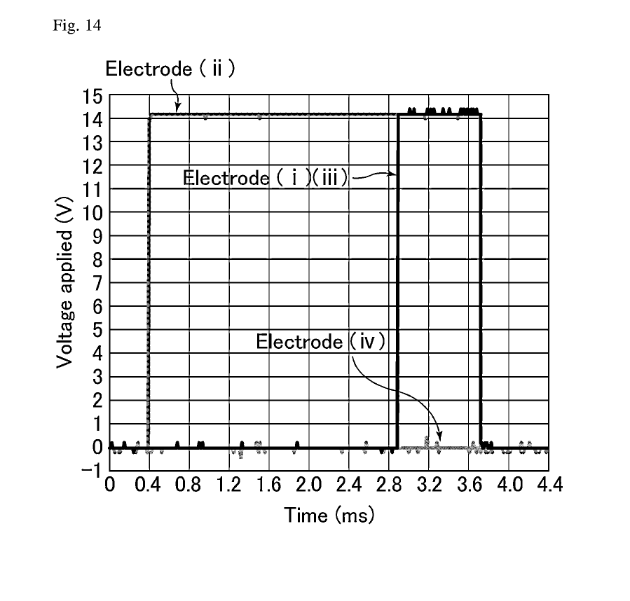

FIG. 12 is a schematic cross-sectional view showing the liquid crystal display panel of Reference Example 3 in the presence of a transverse electric field. FIG. 13 is a schematic cross-sectional view showing the liquid crystal display panel of Reference Example 3 in the presence of a vertical electric field. FIG. 14 is a graph showing the rectangular waves (drive waveforms) applied to the respective electrodes in Reference Example 3. In Reference Example 3, a counter electrode 213 was set to the same electric potential as that of a comb-shaped electrode 217 which is one of the pair of comb-shaped electrodes and a counter electrode 223 was set to 0 V. The other conditions were the same as those in Reference Example 1.

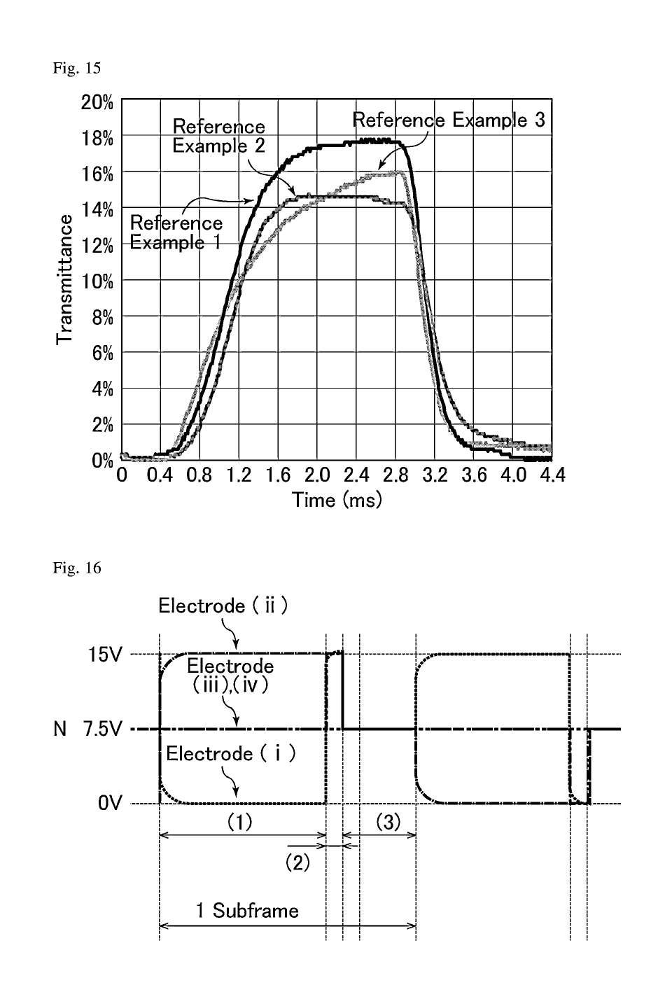

FIG. 15 is a graph showing the measured drive response waveforms in Reference Examples 1 to 3. With respect to Reference Example 2 and Reference Example 3, each of which relates to different driving methods, the response performance and the transmittance were measured in the same manner as in Reference Example 1. For example, the evaluation cell had a cell thickness of 5.4 μm and an electrode gap between the pair of comb-shaped electrodes of 2.6 μm. The measurement temperature was 25° C. In the same manner as in Reference Example 1, Reference Example 2 and Reference Example 3 confirmed that a higher response speed and a higher transmittance than in Comparative Example 1 (simulated transmittance: 3.6%) were provided while maintaining a high response speed, as shown in FIG. 15.

FIG. 16 is a graph showing electric potential changes of the respective electrodes with the initialization step implemented. Driving from a gray scale value of 255 to a gray scale value of 0 usually causes natural relaxation, and thus the response speed is slow. However, application of a vertical electric field to a positive liquid crystal leads to alignment of the liquid crystal in the vertical direction, providing a high response speed. It should be noted that the way of applying a voltage is different between the white state and the black state, and thus the driving method is required to be devised for good gray scale display in actual driving. Examples of the driving methods include those disclosed in Japanese Patent Application No. 2011-061662 and Japanese Patent Application No. 2011-061663, the methods including first providing a completely OFF state and then writing a next gray scale value (FIG. 16).

In this method, at least two driving operations are required for one gray scale value. Thus, the response time is as long as the sum of the OFF time and the ON time (e.g. 0.8 msec (OFF time)+2.4 msec (ON time)). Further, the number of driving operations is more than double and the load on the circuit and the driver is increased. In FIG. 16, the period (1) is a time required for the ON state, and the periods (2) and (3) are times required for the OFF state.

The following will describe TFT driving methods suitably applied to the driving in the aforementioned Reference Examples 1 to 3. In the following TFT driving methods, the number of driving operations is reduced to shorten the response time and to reduce the load on the circuit and the driver.

### Embodiment 1

### Continuous Vertical-Electric-Field Driving

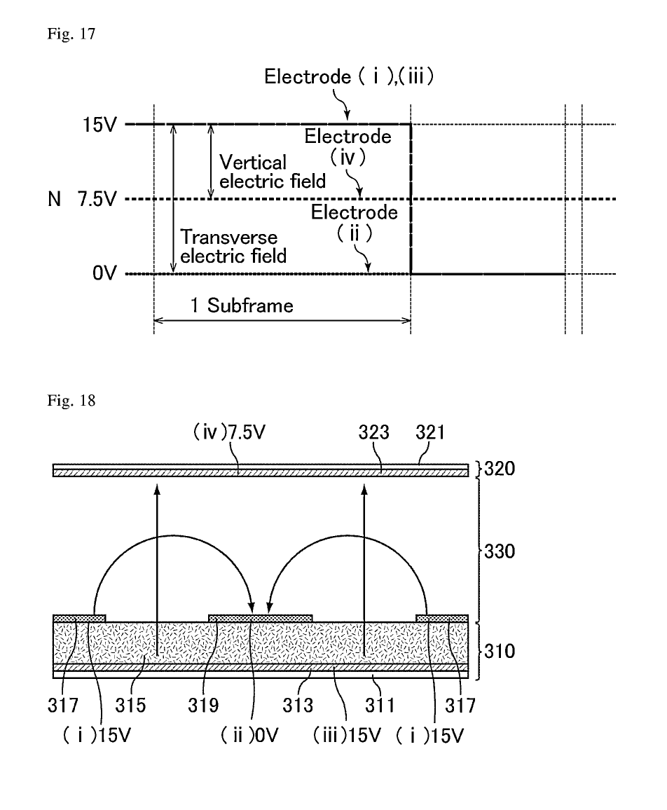

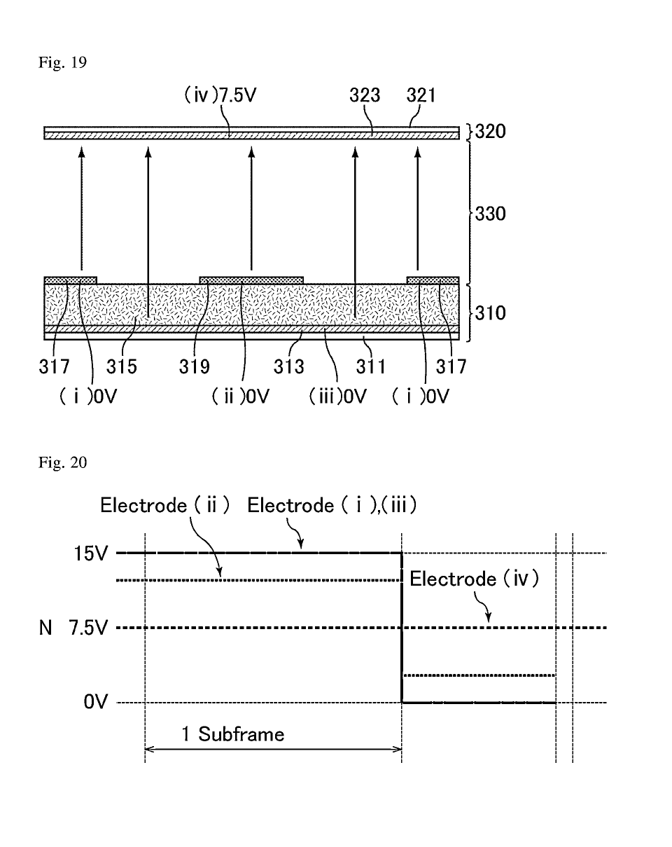

FIG. 17 is a graph showing electric potential changes of the respective electrodes of Embodiment 1 when the gray scale value of a displayed image is changed from 255 to 0. The standard electric potential is repeatedly set from 0 V to 15 V and vice versa so that the polarization is inverted for each frame. In the drawing, the term “vertical electric field” means a voltage applied as a vertical electric field, and the term “transverse electric field” means a voltage applied as a transverse electric field. The same shall apply to the drawings to be mentioned later. FIG. 18 is a schematic cross-sectional view showing the liquid crystal drive device of Embodiment 1 when a displayed image has a gray scale value of 255. In FIG. 18, both the transverse electric field and the vertical electric field are simultaneously generated. The transverse electric field is stronger, and thus leads to a white state. FIG. 19 is a schematic cross-sectional view showing the liquid crystal drive device of Embodiment 1 when a displayed image has a gray scale value of 0. In FIG. 19, only a vertical electric field is generated. Thus, the liquid crystal is aligned orthogonally and leads to a black state.

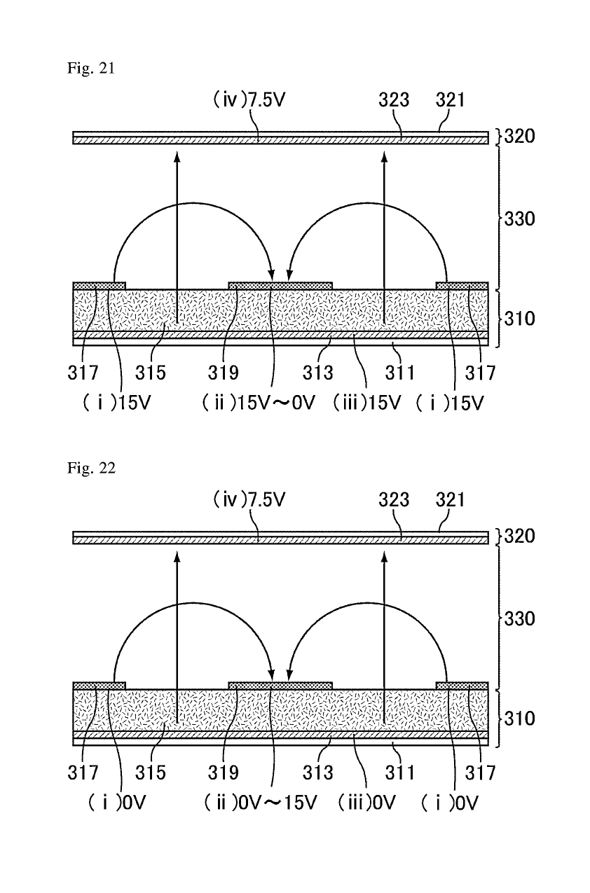

FIG. 20 is a graph showing electric potential changes of the respective electrodes of Embodiment 1 when a halftone image is displayed. FIG. 21 is a schematic cross-sectional view showing the liquid crystal drive device of Embodiment 1 when a halftone image is displayed. FIG. 22 is a schematic cross-sectional view showing the liquid crystal drive device of Embodiment 1 when a halftone (reverse polarity) image is displayed. Table 1 shows the electric potential changes of the respective electrodes of Embodiment 1.

TABLE 1

| | Gray | Gray | | Halftone |
|---|---|---|---|---|
| | scale | scale | | (reverse |
| | value 225 | value 0 | Halftone | polarity) |
| (i) Standard | 15 V | 0 V | 15 V | 0 V |
| potential | | | | |
| (ii) Gray scale | 0 V | 0 V | from 15 V | from 0 V |
| potential | | | to 0 V | to 15 V |
| (iii) Lower layer | 15 V | 0 V | 15 V | 0 V |
| potential | | | | |
| (iv) Common | 7.5 V | 7.5 V | 7.5 V | 7.5 V |
| potential | | | | |

The driving method of Embodiment 1 drives the liquid crystal always in the presence of a vertical electric field when an image is displayed (in this case, the potential difference between the lower electrode (iii) and the counter electrode (iv) is always 7.5 V). In this case, the gray scale value is expressed only by a transverse electric field (an electric field applied between the pair of comb-shaped electrodes). For example, with respect to the electric fields applied to the liquid crystal layer for a gray scale value of 255, the transverse electric field is stronger than the vertical electric field. Thus, the liquid crystal is aligned in the transverse direction and white display is achieved. As the transverse electric field is weakened, the vertical electric field gradually has a stronger influence and the liquid crystal starts to align in the vertical direction. This driving method makes it possible to decide the gray scale value by a single writing, and thus the response speed is high and the circuit is driven at a low frequency. Further, the load on the circuit and the driver is sufficiently decreased.

The liquid crystal display device including the liquid crystal drive device of Embodiment 1 may appropriately include the components that usual liquid crystal display devices have (e.g. light source). The same shall apply to the following embodiments.

### Embodiment 2

### Vertical Electric Field Applied Only to Displayed Image Having Low Gray Scale Value (Standard Electric Potential Fixed to 0 V (15 V))

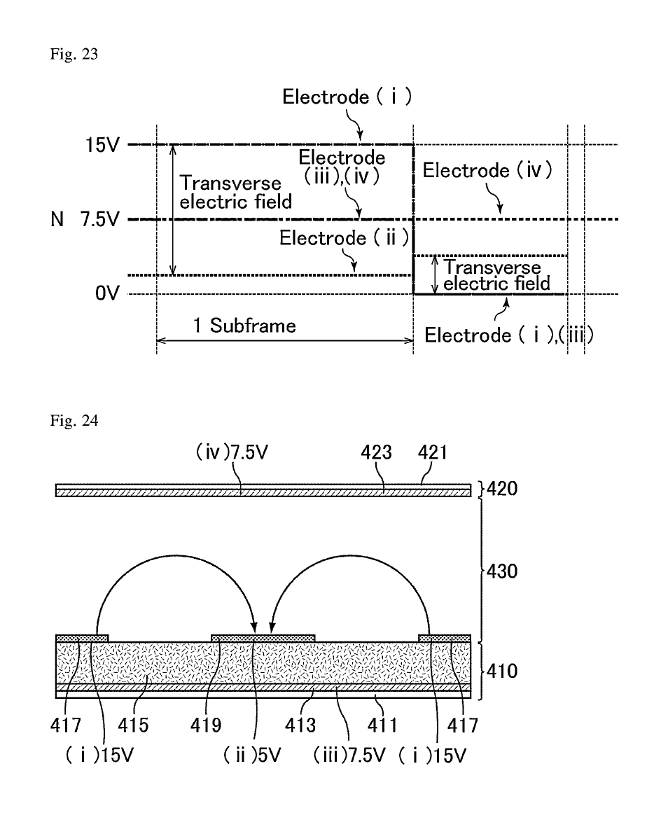

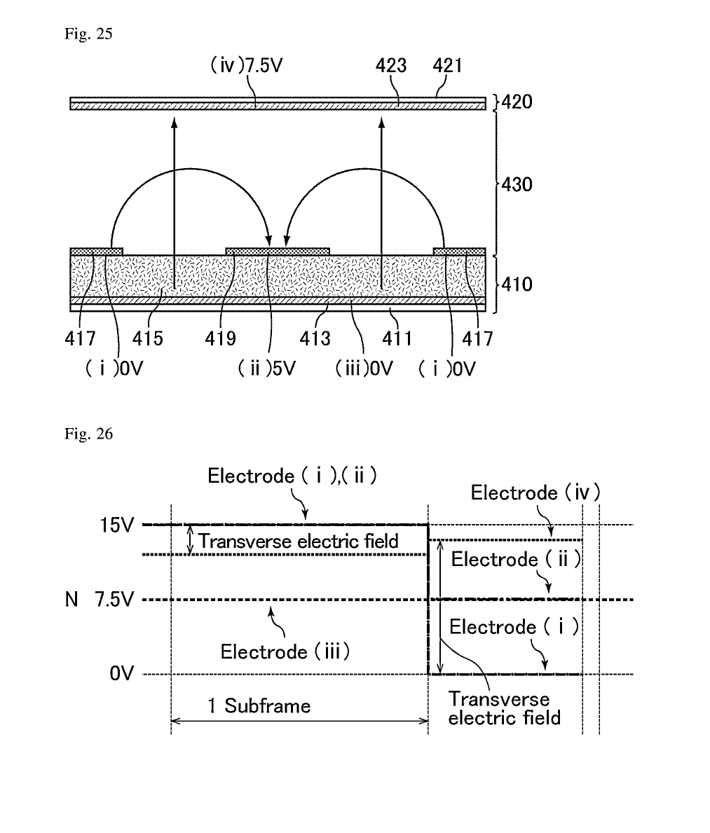

FIG. 23 is a graph showing electric potential changes of the respective electrodes of Embodiment 2 when the gray scale level of a displayed image is changed from a high gray scale value to a low gray scale value (reverse potential). FIG. 24 is a schematic cross-sectional view showing the liquid crystal drive device of Embodiment 2 when a displayed image has a high gray scale value. In FIG. 24, driving is achieved only by a transverse electric field. Since no vertical electric field is applied, a higher transmittance is provided. FIG. 25 is a schematic cross-sectional view showing the liquid crystal drive device of Embodiment 2 when a displayed image has a low gray scale value (reverse potential). In FIG. 25, the vertical electric field allows the liquid crystal to return quickly. The transverse electric field enables gray scale expression.

In driving toward a low gray scale value, the response speed is slow, and thus a vertical electric field is applied so as to increase the response speed. In driving toward a high gray scale value, in contrast, a higher transmittance is provided without a vertical electric field. This means that no vertical electric field is preferably applied in terms of transmittance. Thus, in driving toward a high gray scale value, the driving operation is implemented with the lower electrode and the counter electrode set to the same electric potential. In other words, a vertical electric field is applied when a displayed image has a low gray scale value, whereas a vertical electric field is not applied when a displayed image has a high gray scale value. Such driving is also achieved by a single writing.

FIG. 24 and FIG. 25 show examples of the way of applying a voltage. In these examples, the standard electric potential is fixed to 15 V or 0 V. In this case, for example, line drive inversion makes the voltage (standard electric potential) of the standard electrode (i) in one line uniform, and thus pixels in the same line are advantageously driven in the same manner. In this example, the gray scale electric potential is changed on the basis of the standard electric potential to express gray scales. In other words, the standard electric potential is fixed to 0 V (or 15 V) and a halftone image is displayed on the basis of this voltage. Such driving enables connection of the electrodes in the line direction, and reduction in the number of TFTs also improves the transmittance.

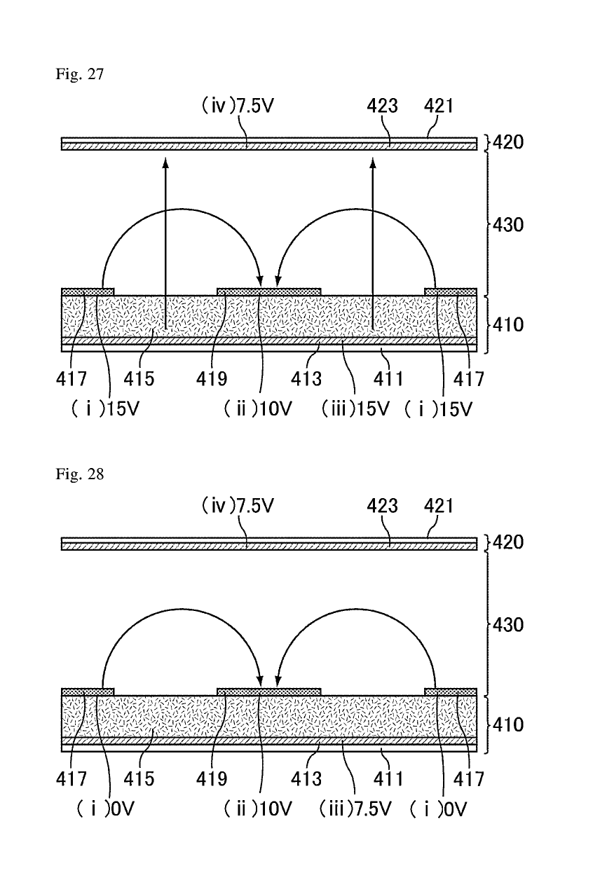

FIG. 26 is a graph showing electric potential changes of the respective electrodes in Embodiment 2 when the gray scale level of a displayed image is changed from a low gray scale value to a high gray scale value (reverse potential). FIG. 27 is a schematic cross-sectional view showing the liquid crystal drive device of Embodiment 2 when a displayed image has a low gray scale value. FIG. 28 is a schematic cross-sectional view showing the liquid crystal drive device of Embodiment 2 when a displayed image has a high gray scale value (reverse potential). Table 2 shows the electric potential changes of the respective electrodes in Embodiment 2.

TABLE 2

| | | High gray | | Low gray |
|---|---|---|---|---|
| | High gray | scale value | Low gray | scale value |
| | scale | (reverse | scale | (reverse |
| | value | potential) | value | potential) |
| (i) Standard | 15 V | 0 V | 15 V | 0 V |
| potential | | | | |
| (ii) Gray scale | 5 V | 10 V | 10 V | 5 V |
| potential | | | | |
| (iii) Lower layer | 7.5 V | 7.5 V | 15 V | 0 V |
| potential | | | | |
| (iv) Common | 7.5 V | 7.5 V | 7.5 V | 7.5 V |
| potential | | | | |

### Embodiment 3

### Only Electric Field of Lower Electrode Changed During Frame

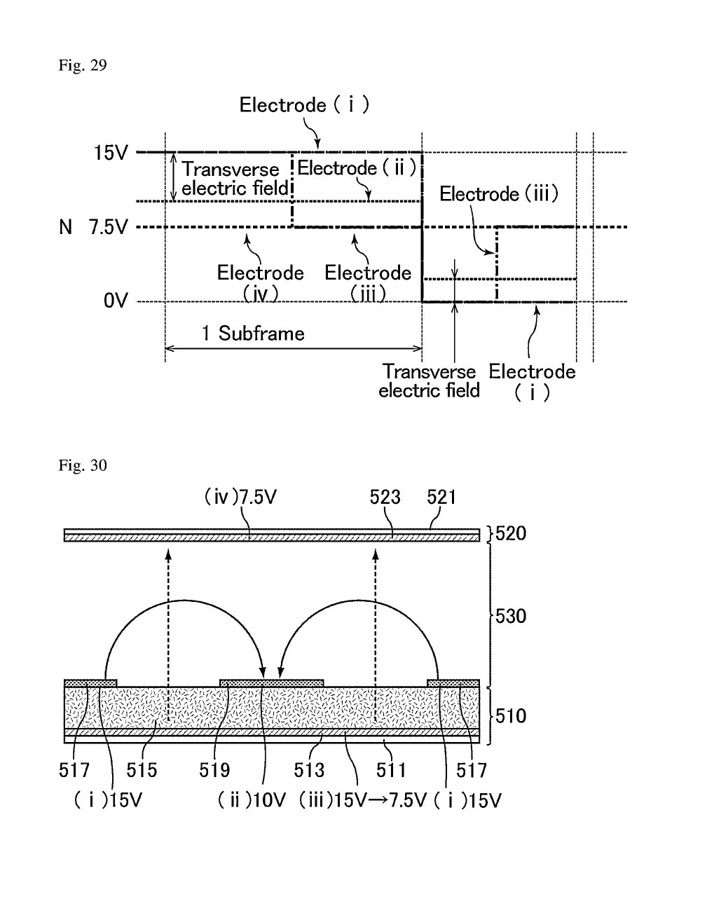

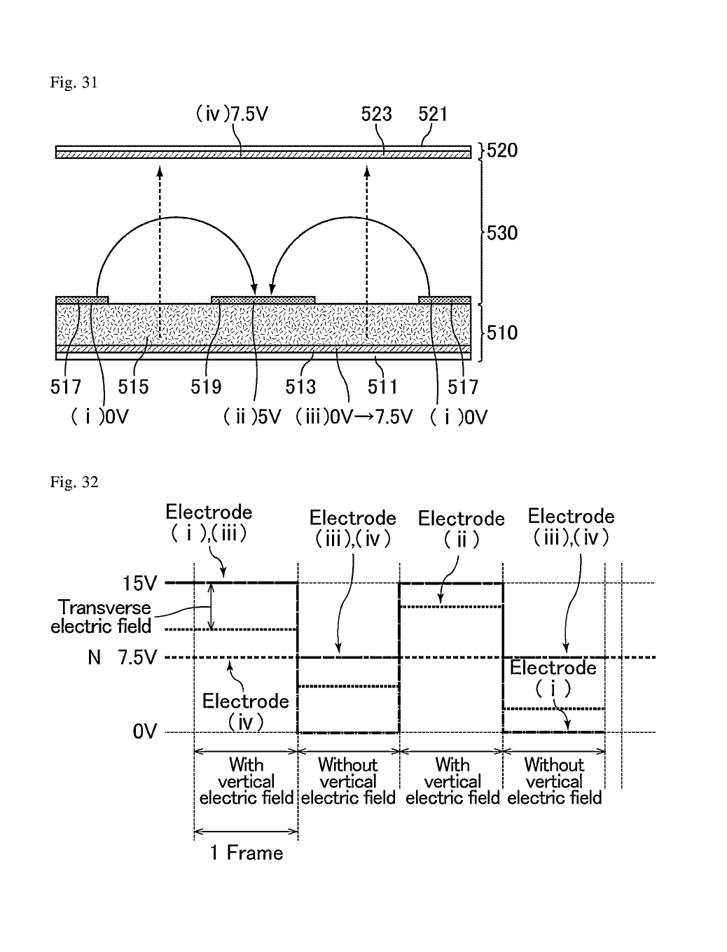

FIG. 29 is a graph showing electric potential changes of the respective electrodes of Embodiment 3 when a halftone image is displayed. FIG. 30 is a schematic cross-sectional view showing the liquid crystal drive device of Embodiment 3 when a halftone image is displayed. FIG. 31 is a schematic cross-sectional view showing the liquid crystal drive device of Embodiment 3 when a halftone image is displayed (reverse potential). Table 3 shows the electric potential changes of the respective electrodes of Embodiment 3.

TABLE 3

| | | Halftone |
|---|---|---|
| | Halftone | (reverse polarity) |
| (i) Standard | 15 V | 0 V |
| potential | | |
| (ii) Gray scale | 10 V | 5 V |
| potential | | |
| (iii) Lower layer | 15 V → 7.5 V | 0 V → 7.5 V |
| potential | | |
| (iv) Common | 7.5 V | 7.5 V |
| potential | | |

### (Standard Electric Potential Fixed to 0 V or 15 V)

In Embodiment 3, only the voltage of the electrode (iii) is changed from 15 V (or 0 V) to 7.5 V during one frame. In the former half, a vertical electric field is applied and a high response speed is provided even when a displayed image has a low gray scale value. In the latter half, a vertical electric field is removed and the gray scale value is adjusted to a predetermined value. The difference between the former and latter halves is only the presence or absence of a vertical electric field and the halves have a similar electric field distribution. Thus, a high response speed is provided even at high gray scale values. The voltage applied to the pair of comb-shaped electrodes (electrode (i) and electrode (ii)) in this period may always be set to a voltage corresponding to a gray scale desired to be displayed in this frame, and requires no rewriting halfway. The driving method in Embodiment 3 is similar to a driving method including an initialization step, but the driving method in Embodiment 3 characteristically includes no returning to black display and no change in the electric potential between the pair of comb-shaped electrodes (electrode (i) and electrode (ii)) during one frame. In addition, for example, frame inversion drives the lower electrodes at the same time, thereby suppressing the load on the circuit and the driver at a relatively low level.

The aforementioned Embodiment 3 changes a vertical electric field during a subframe and this is one of preferable modes. The vertical electric field may also be changed between subframes, and this mode also provides the effects of the present invention. The following will describe one modified example of Embodiment 3 in which a vertical electric field is changed in each frame and another one in which a vertical electric field is applied only when a gray scale value is changed and no vertical electric field is applied when a gray scale value is maintained.

### First Modified Example of Embodiment 3

### Vertical Electric Field Changed in Each Frame

FIG. 32 is a graph showing electric potential changes in the respective electrodes in the first modified example of Embodiment 3 when an image is displayed.

The first modified example of Embodiment 3 shows driving in which a vertical electric field is applied in a first frame and no vertical electric field is applied in a second frame.

### Second Modified Example of Embodiment 3

### Vertical Electric Field Applied when Gray Scale Value Changed and No Vertical Electric Field Applied when Gray Scale Value Maintained

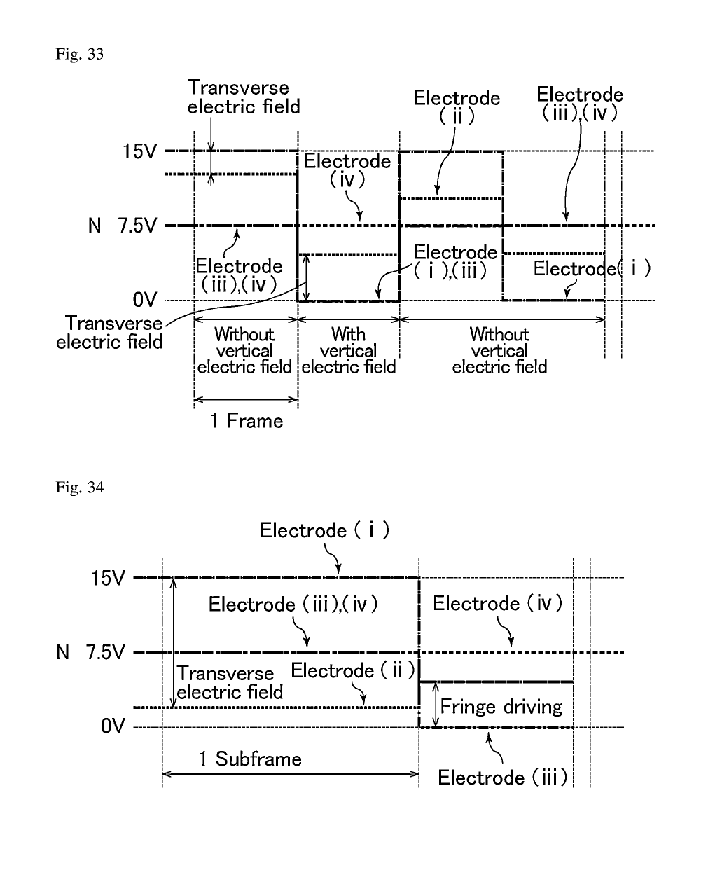

FIG. 33 is a graph showing electric potential changes in the respective electrodes in the second modified example of Embodiment 3 when an image is displayed.

The second modified example of Embodiment 3 shows driving in which a vertical electric field is applied at the timing of a great change in a gray scale value (during a frame where a gray scale value greatly changes) but no vertical electric field is applied at the other timings. In the case of OD (overdrive), for example, a first frame (corresponding to a second frame in FIG. 33) is driven with a vertical electric field to provide a high response speed, and second or later frames (corresponding to third or later frames in FIG. 33) are driven without a vertical electric field to maintain the gray scale value.

### Embodiment 4

### Fringe Driving at Low Gray Scale Values

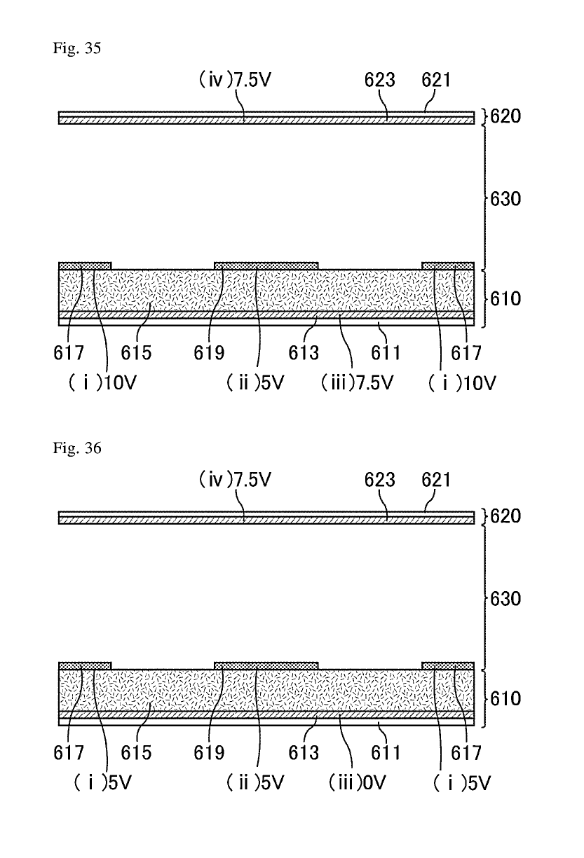

FIG. 34 is a graph showing electric potential changes of the respective electrodes of Embodiment 4 when the gray scale value of a displayed image is changed from a high gray scale value to a low gray scale value (reverse potential). In the drawing, the term “fringe driving” means fringe driving is implemented on the basis of a potential difference. FIG. 35 is a schematic cross-sectional view showing the liquid crystal drive device of Embodiment 4 when a displayed image has a high gray scale value. FIG. 36 is a schematic cross-sectional view showing the liquid crystal drive device of Embodiment 4 when a displayed image has a low gray scale value (reverse potential).

Also in Embodiment 4, a vertical electric field is applied for a higher response speed at low gray scale values. In the present embodiment, the electric potential of a standard electrode (i) and the electric potential of a gray scale electrode (ii) are at the same phase, and fringe driving is implemented on the basis of the potential difference between each of the above electric potentials and the electric potential of the lower electrode (iii) to further increase the response speed at low gray scale values. In this case, a gray scale value of 0 provides the same electric potential (0 V) for the standard electrode (i), the gray scale electrode (ii), and the lower electrode (iii), leading to application of a vertical electric field to the liquid crystal. As the gray scale value is changed, the electric fields of the standard electrode (i) and the gray scale electrode (ii) (upper electrode) are changed. Since the counter electrode (iv) is 7.5 V, a voltage is applied even at low gray scale values by starting the driving with the potential of the lower electrode (iii) set to 0 V, thereby providing a high response speed. With the counter electrode (iv) set to 0 V, a gray scale value of 0 provides the same electric potential (7.5 V) for the standard electrode (i), the gray scale electrode (ii), and the lower electrode (iii), leading to application of a vertical electric field to the liquid crystal. As the gray scale value is changed, the electric fields of the standard electrode (i) and the gray scale electrode (ii) (upper electrodes) are changed. Since the counter electrode (iv) is 0 V, a voltage is applied even at low gray scale values by starting the lower electrode (iii) not from 0 V but from 7.5 V, thereby providing a high response speed. Instead of the standard electrode (i) and the gray scale electrode (ii), the lower electrode (iii) may be driven.

The fringe driving does not provide a transmittance at high gray scale values, and thus the comb driving is implemented at high gray scale values. This makes it possible to simultaneously provide a high response speed and a high transmittance with a low voltage.

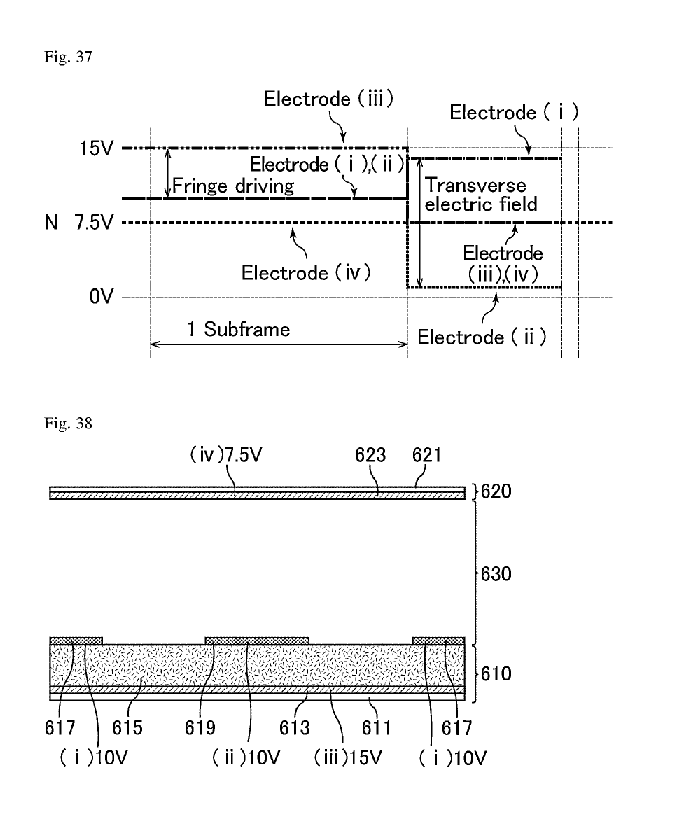

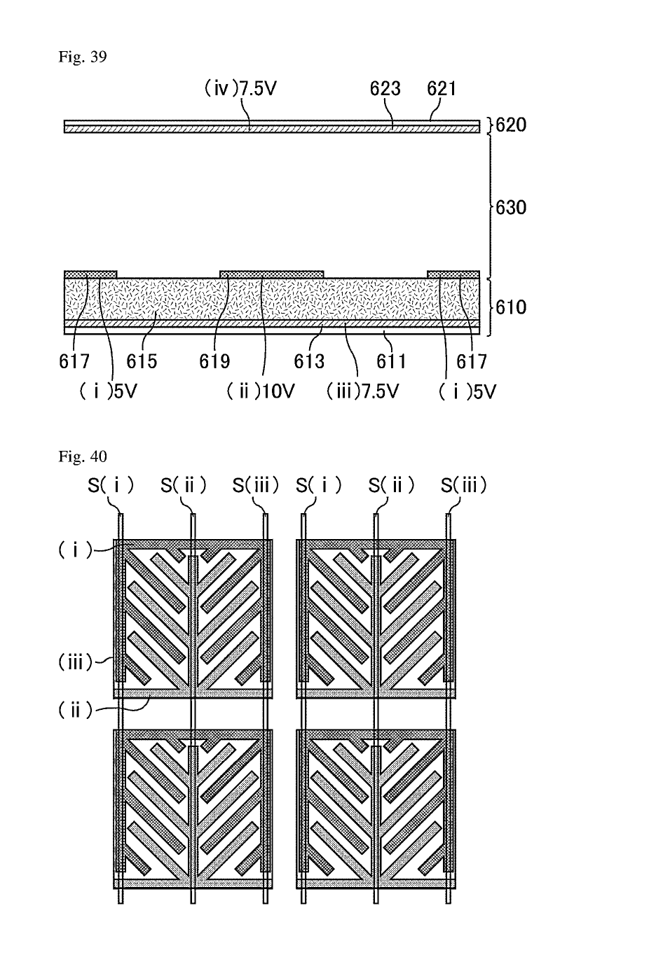

FIG. 37 is a graph showing electric potential changes of the respective electrodes of Embodiment 4 when the gray scale level of a displayed image is changed from a low gray scale value to a high gray scale value (reverse potential). FIG. 38 is a schematic cross-sectional view showing the liquid crystal drive device of Embodiment 4 when a displayed image has a low gray scale value. FIG. 39 is a schematic cross-sectional view showing the liquid crystal drive device of Embodiment 4 when a displayed image has a high gray scale value (reverse potential).

### (Basic Design Pattern for Driving Three Electrodes)

FIG. 40 to FIG. 45 each are a schematic plan view showing one embodiment of the design pattern of the drive device of the present invention.

The three electrodes on the TFT side are required to be driven separately, and thus each subpixel requires three TFTs. However, an increase in the number of TFTs leads to a decrease in the aperture ratio. Thus, the design pattern should be elaborated.

In FIG. 40 to FIG. 45, the symbol (i) indicates an upper ITO (indium tin oxide) (a standard electrode); the symbol (ii) indicates an upper ITO (a gray scale electrode); the symbol (iii) indicates a lower ITO (lower electrode); the symbols S(i), S(ii), and S(iii) indicate source lines for applying voltages to the electrodes (i), (ii), and (iii), respectively; the symbols M and M′ indicate metal lines other than the source lines, such as gate lines; and the symbol C indicates a contact hole. In addition to ITO, the electrodes may be formed from any known materials such as IZO (indium zinc oxide).

In FIG. 40 to FIG. 45, the pixels are aligned vertically or transversely. This is because the metal lines (e.g. source lines) preferably overlap the ITO trunks (main lines) constituting the electrodes for a higher transmittance, and thus the alignment of the pixels is appropriately adjusted in FIG. 40 to FIG. 45. The pixels may basically be aligned in either way. The main lines of the electrodes (ITO or IZO) electrically connected in each pixel line preferably overlap the metal line in a plan view of the main faces of the substrates. Since the metal line usually transmits no light, the aforementioned placement of the main line of the electrodes electrically connected in each pixel line increases the aperture ratio. The metal line is preferably one line selected from the group consisting of source bus lines, gate bus lines, and metal lines for capacitance reduction.

### (A) 3-TFT Driving

FIG. 40 shows driving with three TFTs (not shown) for each subpixel. In the driving (A), three electrodes (a standard electrode (i) and a gray scale electrode (ii) (the first electrode pair), and a lower electrode (iii) (one electrode of the second electrode pair)) disposed on the lower substrate (second substrate) are separately driven and are allowed to have different electric potentials. Thus, each subpixel requires three source lines and three TFTs. The symbol S(i) indicates a source line for the standard electrode (i); the symbol S(ii) indicates a source line for the gray scale electrode (ii); and the symbol S(iii) indicates a source line for the lower electrode (iii). The 3-TFT driving may be implemented by any of the driving methods mentioned herein, and it causes less signal delay and is advantageously used for a large-size liquid crystal drive devices and liquid crystal display devices.

(B-1) 2-TFT Driving with Lower Electrodes Commonly Used

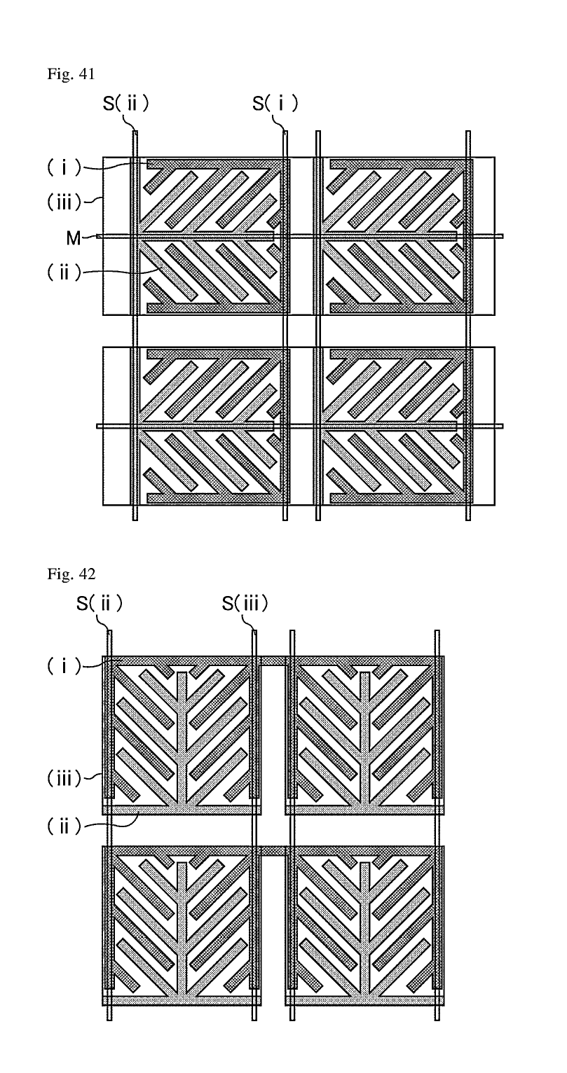

FIG. 41 shows driving with two TFTs for each subpixel and lower electrodes are commonly used in the transverse line direction. In the driving (B-1), the lower electrodes (iii) (each corresponds to one electrode of the second electrode pair) disposed on the lower substrate (second substrate) are electrically connected in each pixel line.

In other words, voltages are applied to the standard electrode (i) and the gray scale electrode (ii) from the source lines S(i) and S(ii), respectively, for separated driving.

With respect to the lower electrodes (iii), lower electrodes are commonly used in the transverse line direction (gate line direction); in other words, lower electrodes (iii) are commonly connected in the transverse line direction. This makes it possible to reduce the number of TFTs and the number of source lines to increase the aperture ratio (the connection may be in the vertical line direction, and this also increases the aperture ratio). With a large-size panel, the resistance of the lower electrode is so high that the waveform may be rounded. Thus, it is preferable that the commonly connected ITO such as the lower electrode is electrically connected with metal to reduce the resistance in a large-size panel.

The 2-TFT driving with a common lower electrode increases the aperture ratio.

(B-2) 2-TFT Driving with Standard Electrodes (Gray Scale Electrodes) Commonly Used

FIG. 42 shows driving with two TFTs for each subpixel and standard electrodes (i) commonly used in the transverse line direction. In the driving (B-2), standard electrodes (i) each of which corresponds to one electrode of the first electrode pair disposed on the second substrate (lower substrate) are electrically connected in each pixel line.

Voltages are applied to the gray scale electrode (ii) and the lower electrode (iii) from the source lines for separated driving. The standard electrode (i) may be shared in the transverse line direction as shown in FIG. 42. It may be shared in the vertical line.

With respect to the gray scale electrodes (ii), a counter electrode may be used in the transverse line direction (gate direction) to reduce the number of TFTs and the number of sources and to increase the aperture ratio (the electrode may be shared in the vertical line direction). In this case, it is preferable that the commonly connected ITO such as standard electrode is electrically connected with metal.

The 2-TFT driving with standard electrodes (gray scale electrodes) commonly used increases the aperture ratio.

(B-3) 2-TFT Driving with Lower Electrode and Standard Electrode Shared

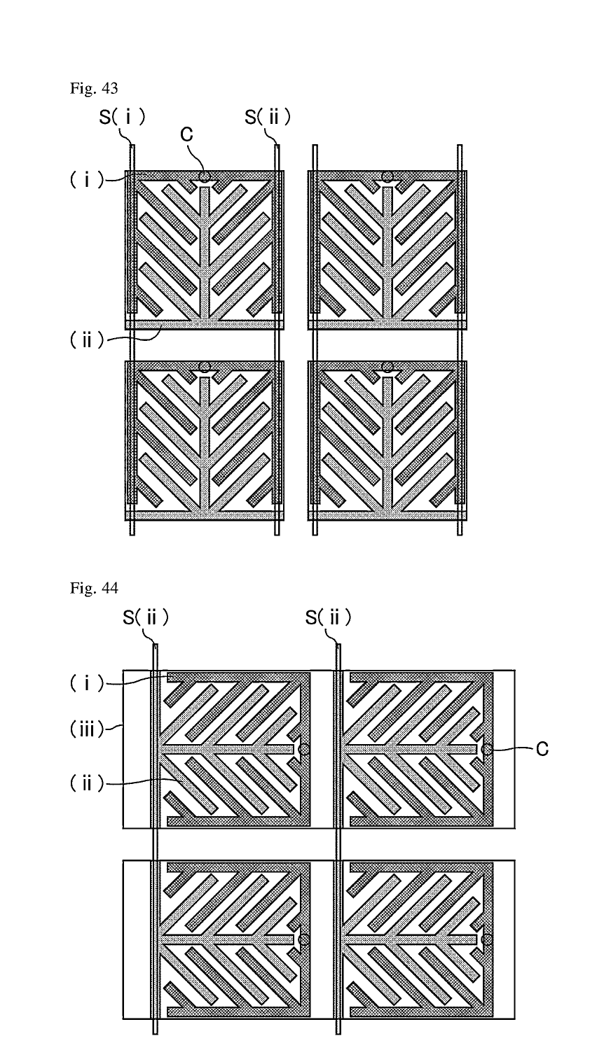

FIG. 43 shows driving with two TFTs for each subpixel and a lower electrode and a standard electrode (i) shared. In the driving (B-3), the two electrodes (the standard electrode (i) (one electrode of the first electrode pair) and the lower electrode (iii) (one electrode of the second electrode pair)) disposed on the lower substrate (second substrate) are electrically connected.

In this case, the gray scale electrode (ii) receives a voltage from the source line S(ii) for separated driving.

On the other hand, the standard electrode (i) receives a voltage from the source line S(i). Here, in order to reduce the number of TFTs, the standard electrode (i) may be connected (electrically connected) with the lower electrode (iii) through a contact hole. This eliminates the need for TFTs and source lines for the lower electrode (iii).

The 2-TFT driving with a common lower electrode and a common standard electrode increases the aperture ratio, as well as further reduces the resistance of the commonly connected electrode in comparison with the other 2-TFT driving methods (B-1) and (B-2).

(C-1) 1-TFT Driving with Lower Electrode and Standard Electrode Shared

FIG. 44 shows driving with one TFT for each subpixel and a lower electrode (iii) and a standard electrode (i) shared. In the driving (C-1), the lower electrodes (iii) (each of which corresponds to one electrode of the second electrode pair) are electrically connected in each pixel line, and the two electrodes (the standard electrode (i) (one electrode of the first electrode pair) and the lower electrode (iii) (one electrode of the second electrode pair)) disposed on the second substrate are electrically connected. In other words, at least one electrode of the first electrode pair is electrically connected with one of the second electrode pair. The liquid crystal drive device includes multiple pixels for display. Electrodes each of which corresponds to one of the second electrode pair and/or electrodes each of which corresponds to the other of the second electrode pair are electrically connected along a pixel line. Such a mode is also one preferable mode of the present invention.

The gray scale electrode (ii) receives a voltage from the source line S(ii) for separate driving.

The number of TFTs and the number of sources are reduced by sharing the lower electrode (iii) in the transverse direction (or vertical direction) to input a signal for each line. Connection between the standard electrode (i) and the lower electrode (iii) through a contact hole provides a drive device with one TFT for each subpixel.

The 1-TFT driving with the lower electrode (iii) and the standard electrode (i) shared maximizes the aperture ratio, and can be suitably used for small-size and middle-size liquid crystal drive devices and liquid crystal display devices.

(C-2) 1-TFT Driving with Lower Electrodes Commonly Used and Standard Electrodes Commonly Used

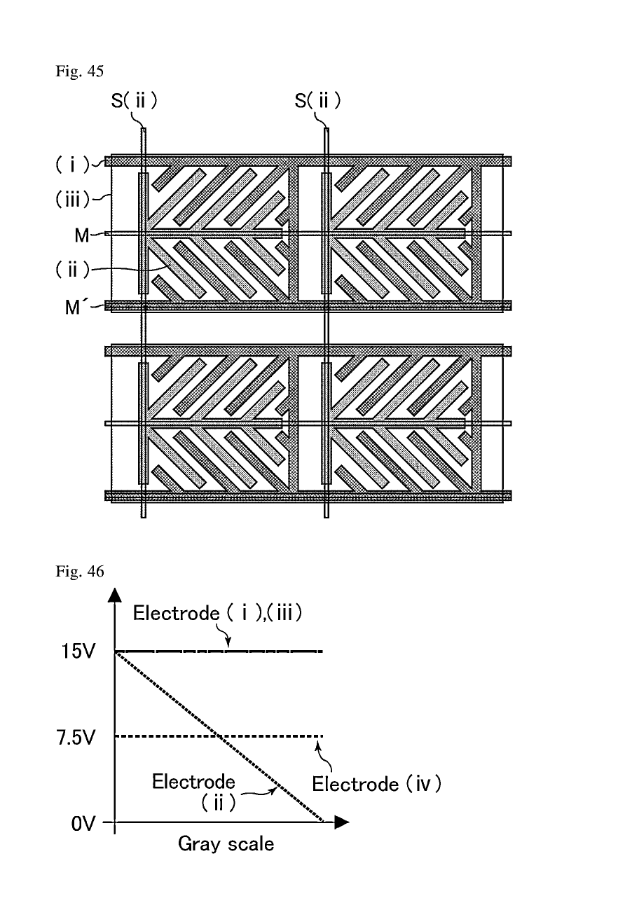

FIG. 45 shows driving with one TFT for each subpixel, the lower electrode (iii) shared along the pixel line, and the standard electrode (i) shared along the pixel line. In the driving (C-2), the lower electrodes (iii), each of which corresponds to one electrode of the second electrode pair, are electrically connected in each pixel line, and the standard electrodes (i), each of which corresponds to one electrode of the first electrode pair disposed on the second substrate, are also electrically connected in each pixel line.

The gray scale electrode (ii) receives a voltage from the source line S(ii) for separated driving.

The number of TFTs and the number of sources are reduced by sharing the lower electrode (iii) in the transverse direction (or vertical direction) and sharing the standard electrode (i) in the transverse direction (or vertical direction) to input a signal for each line. Electric connection between the standard electrode (i) and the lower electrode (iii) in each pixel line provides a drive device with one TFT for each subpixel. In order to reduce the resistance, the commonly connected standard electrode such as ITO and/or the commonly connected lower electrode such as ITO are/is preferably electrically connected with metal.

The 1-TFT driving with the lower electrodes (iii) commonly used and the standard electrodes (i) commonly used maximizes the aperture ratio, and is suitably used for small-size and middle-size liquid crystal drive devices and liquid crystal display devices.

The term “small-size liquid crystal drive device” herein means 10 or smaller inch displays for mobile devices. The term “middle-size liquid crystal drive device” means 20 or smaller inch displays for devices such as personal computers. The term “large-size panel” means displays greater than the aforementioned sizes for devices such as televisions.

Combination of the driving methods of Embodiments 1 to 4 and the design patterns (A), (B-1), (B-2), (B-3), (C-1), and (C-2) (six patterns in total) provides various driving methods. Each driving method has its strong point, and thus it is possible to provide an optimum driving method depending on the panel design. Specifically, with respect to Embodiment 1 (continuous electric field driving), drivable design patterns are all of the patterns (A), (B-1), (B-2), (B-3), (C-1), and (C-2). With respect to Embodiment 2 (a vertical electric field is applied only when a displayed image has a low gray scale value (the standard electric potential is fixed to 0 V (15 V))), drivable design patterns are the patterns (A) and (B-2). With respect to Embodiment 3 (an electric field is changed during one frame only in the lower electrode), in which the standard electric potential is fixed to 0 V or 15 V, the drivable design patterns are the patterns (A), (B-1), and (B-2). With respect to Embodiment 4 (fringe driving is implemented at low gray scale values), the drivable design patterns are the patterns (A) and (B-1) when the upper electrodes are driven in fringe driving or the patterns (A) and (B-2) when the lower electrode is driven in fringe driving.

The strong points of the respective combinations of the pixel designs and the voltage application patterns are as follows. For example, a liquid crystal drive device with the combination of Embodiment 1 and the pattern (A) is preferred in that it implements a driving operation that generates a potential difference between the electrodes of the first electrode pair and simultaneously generates a potential difference between the electrodes of the second electrode pair when a displayed image has a gray scale value that is greater than half of the total number of gray scale values for image display, thereby separately driving the three electrodes (both electrodes of the first electrode pair and one electrode of the second electrode pair) disposed on the second substrate, and providing different electric potentials for the electrodes. This suppresses signal delay and allows the device to be advantageously used for large-size liquid crystal drive devices and liquid crystal display devices.

A liquid crystal drive device with the combination of Embodiment 2 and the pattern (A) is also preferred in that it implements a driving operation that generates a potential difference between the electrodes of the first electrode pair but simultaneously generates no potential difference between the electrodes of the second electrode pair when a displayed image has a gray scale value that is greater than half of the total number of gray scale values for image display, thereby separately driving the three electrodes (both electrodes of the first electrode pair and one electrode of the second electrode pair) disposed on the second substrate, and providing different electric potentials for the electrodes. A liquid crystal drive device with the combination of Embodiment 3 and the pattern (A) is also preferred in that it implements a driving operation that changes the electric potential of one electrode of the second electrode pair during a subframe that is a drive cycle of driving the liquid crystal to display an image, thereby separately driving the three electrodes (both electrodes of the first electrode pair and one electrode of the second electrode pair) disposed on the second substrate, and providing different electric potentials for the electrodes. A liquid crystal drive device with the combination of Embodiment 4 and the pattern (A) is also preferred in that it implements a driving operation that generates no potential difference between the first electrode pair but generates a potential difference between each electrode of the first electrode pair and one electrode of the second electrode pair, and simultaneously generates a potential difference between the electrodes of the second electrode pair when a displayed image has a gray scale value that is half or smaller of the total number of gray scale values for image display, thereby separately driving the three electrodes (both electrodes of the first electrode pair and one electrode of the second electrode pair) disposed on the second substrate, and providing different electric potentials for the electrodes.

A liquid crystal drive device with the combination of Embodiment 1 and the pattern (B-1) is preferred in that it implements a driving operation that generates a potential difference between the electrodes of the first electrode pair and generates a potential difference between the electrodes of the second electrode pair when a displayed image has a gray scale value that is greater than half of the total number of gray scale values for image display, and in that electric connection of electrodes each of which corresponds to one electrode disposed on the second substrate (one electrode of the second electrode pair) in each pixel line increases the aperture ratio. A liquid crystal drive device with the combination of Embodiment 3 and the pattern (B-1) is also preferred in that it changes the electric potential of one electrode of the second electrode pair during a subframe that is a drive cycle of driving the liquid crystal to display an image, and in that electric connection of electrodes each of which corresponds to one electrode disposed on the second substrate (one electrode of the second electrode pair) in each pixel line provides the same effect. A liquid crystal drive device with the combination of Embodiment 4 and the pattern (B-1) is also preferred in that it implements a driving operation that generates no potential difference between the electrodes of the first electrode pair but generates a potential difference between each electrode of the first electrode pair and one electrode of the second electrode pair and simultaneously generates a potential difference between the electrodes of the second electrode pair when a displayed image has a gray scale value that is half or smaller of the total number of gray scale values for image display, and in that electric connection of electrodes each of which corresponds to one electrode disposed on the second substrate (one electrode of the second electrode pair) in each pixel line provides the same effect.

A liquid crystal drive device with the combination of Embodiment 1 and the pattern (B-2) is preferred in that it implements a driving operation that generates a potential difference between the electrodes of the first electrode pair and simultaneously generates a potential difference between the electrodes of the second electrode pair when a displayed image has a gray scale value that is greater than half of the total number of gray scale values for image display, and in that electric connection of electrodes each of which corresponds to one electrode of the first electrode pair disposed on the second substrate in each pixel line increases the aperture ratio. A liquid crystal drive device with the combination of Embodiment 2 and the pattern (B-2) is also preferred in that it implements a driving operation that generates a potential difference between the electrodes of the first electrode pair but simultaneously generate no potential difference between the electrodes of the second electrode pair when a displayed image has a gray scale value that is greater than half of the total number of gray scale values for image display, and in that electric connection of electrodes each of which corresponds to one electrode of the first electrode pair disposed on the second substrate in each pixel line provides the same effect. A liquid crystal drive device with the combination of Embodiment 3 and the pattern (B-3) is also preferred in that it changes the electric potential of one electrode of the second electrode pair during a subframe that is a drive cycle of driving the liquid crystal to display an image, and in that electric connection of electrodes each of which corresponds to one electrode of the first electrode pair disposed on the second substrate in each pixel line provides the same effect. A liquid crystal drive device with the combination of Embodiment 4 and the pattern (B-2) is also preferred in that it implements a driving operation that generates no potential difference between the electrodes of the first electrode pair but generates a potential difference between each electrode of the first electrode pair and one electrode of the second electrode pair and simultaneously generates a potential difference between the electrodes of the second electrode pair when a displayed image has a gray scale value that is half or smaller of the total number of gray scale values for image display, and in that electric connection of electrodes each of which corresponds to one electrode of the first electrode pair disposed on the second substrate in each pixel line provides the same effect.

A liquid crystal drive device with the combination of Embodiment 1 and the pattern (B-3) is preferred in that it implements a driving operation that generates a potential difference between the electrodes of the first electrode pair and simultaneously generates a potential difference between the electrodes of the second electrode pair when a displayed image has a gray scale value that is greater than half of the total number of gray scale values for image display, and in that the two electrodes (one electrode of the first electrode pair and one electrode of the second electrode pair) disposed on the second substrate are electrically connected to reduce the resistance and to increase the aperture ratio.

A liquid crystal drive device with the combination of Embodiment 1 and the pattern (C-1) implements a driving operation that generates a potential difference between the electrodes of the first electrode pair and simultaneously generates a potential difference between the electrodes of the second electrode pair when a displayed image has a gray scale value that is greater than half of the total number of gray scale values for image display. Further, in such a device, electrodes each of which corresponds to one electrode of the second electrode pair are electrically connected in each pixel line and the two electrodes (one electrode of the first electrode pair and one electrode of the second electrode pair) disposed on the second substrate are electrically connected. This combination is one optimum combination, and provides the highest transmittance. A liquid crystal drive device with the combination of Embodiment 1 and the pattern (C-2) implements a driving operation that generates a potential difference between the electrodes of the first electrode pair and simultaneously generates a potential difference between the electrodes of the second electrode pair when a displayed image has a gray scale value that is greater than half of the total number of gray scale values for image display. Further, in such a device, electrodes each of which corresponds to one electrode of the second electrode pair are electrically connected in each pixel line and electrodes each of which corresponds to one electrode of the first electrode pair are electrically connected in each pixel line. This combination is one optimum combination, and provides the highest transmittance.

The above embodiments describe the cases where electrodes are electrically connected in each odd-numbered pixel line and in each even-numbered pixel line, and such a mode is preferred for inversion driving. Still, the electrodes are at least electrically connected along the pixel line. For example, the electrodes may be connected in each pixel line, or the electrodes may be connected in every multiple pixel lines (in every n lines (n is an integer of 2 or greater)).

### (Voltage Application Method)

The following will specifically describe the voltage application methods which are suitably applied to the above embodiments.

FIG. 46 is a graph showing one mode of the voltage application method of the drive device in Embodiment 1 (continuous vertical-electric-field driving). A vertical electric field is always applied and only the gray scale electrode (ii) is driven.

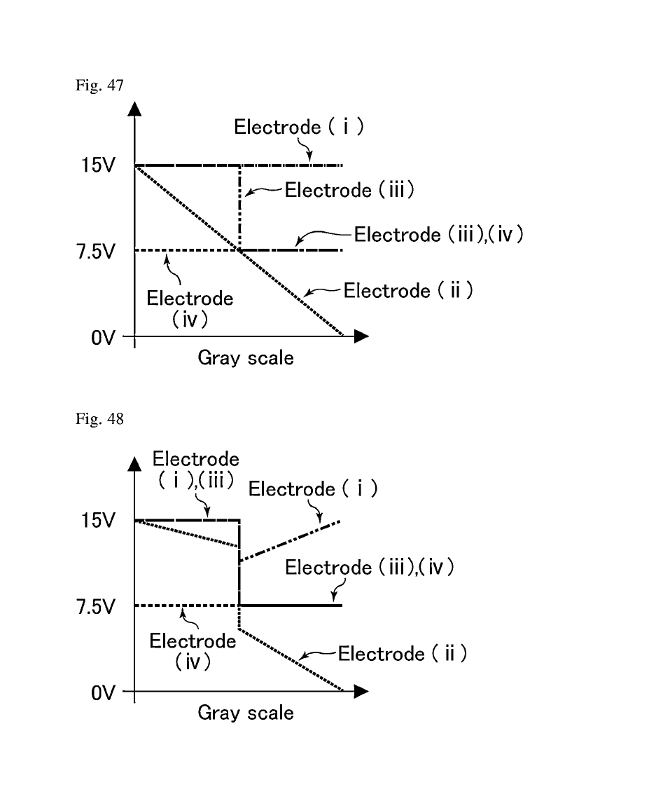

FIG. 47 and FIG. 48 each are a graph showing one mode of the voltage application method in the drive device of Embodiment 2 (transverse electric field used in combination). As shown in FIG. 47, removal of a vertical electric field at high gray scale values increases the transmittance. As shown in FIG. 48, a transverse electric field may be uniformly applied to the pair of opposing comb-shaped electrodes after the removal of a vertical electric field.

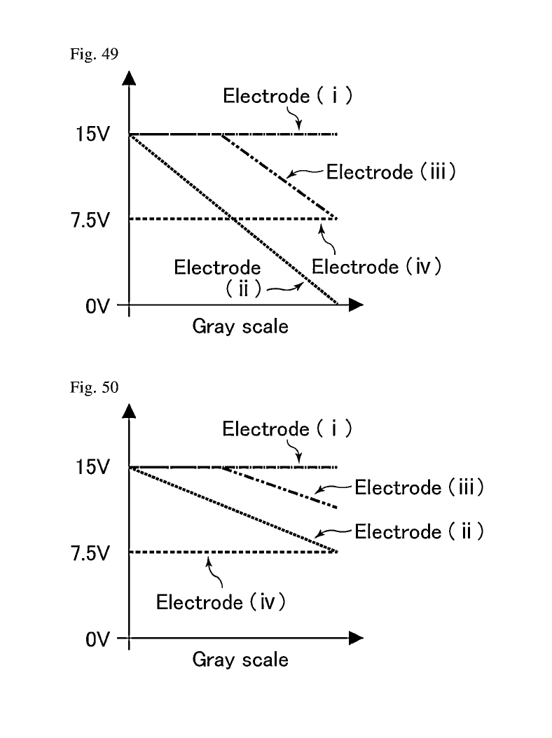

FIG. 49 and FIG. 50 each are also a graph showing one mode of the voltage applying method in the drive device of Embodiment 2. In FIG. 49, a vertical electric field is gradually decreased. In FIG. 50, a vertical electric field is gradually decreased at high gray scale values but a small amount of a vertical electric field is still applied even at high gray scale values. As mentioned here, it is particularly preferred to apply a small amount of a vertical electric field even at high gray scale values for a high response speed. In applying a voltage as shown in FIG. 49 and FIG. 50, a vertical gray scale is preferably applied when the gray scale value of a displayed image is ¼ or lower of the total number of gray scale values for image display. For example, the vertical electric field preferably starts to drop around the point where the gray scale value of a displayed image is ¼ of the total number of gray scale values for image display.

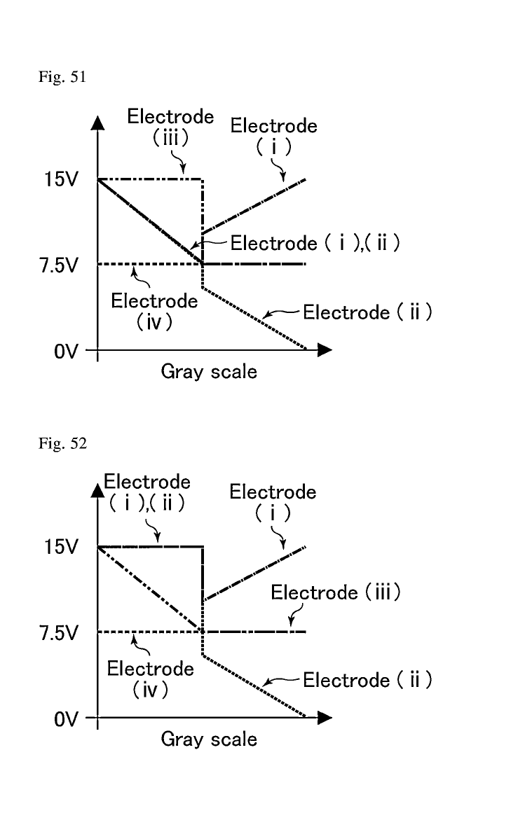

FIG. 51 and FIG. 52 each are a graph showing one mode of the voltage application method of the drive device in Embodiment 4 (combination use of fringe driving).

In FIG. 51 and FIG. 52, fringe driving is implemented at low gray scale values. FIG. 51 shows a method of driving an upper electrode. FIG. 52 shows a method of driving a lower electrode.

### (Advantages of Applying Vertical Electric Field)

The liquid crystal more quickly responds to a signal by an electric field. However, in the case of low-gray-scale driving (e.g. from a gray scale value of 0 to a gray scale value of 32), driving only with a transverse electric field applies a low voltage to the liquid crystal, causing a low response speed. This is because the strength of the vertical alignment liquid crystal is at the same level as the strength of the electric field for transversely aligning the liquid crystal, and thus the liquid crystal is less likely to align.

Here, application of a vertical electric field causes the liquid crystal to align in the direction of the synthesized vector of the vertical electric field and the transverse electric field. The strength of the electric field is higher than the strength of the liquid crystal to align in the vertical direction, resulting in a higher response speed of the liquid crystal.

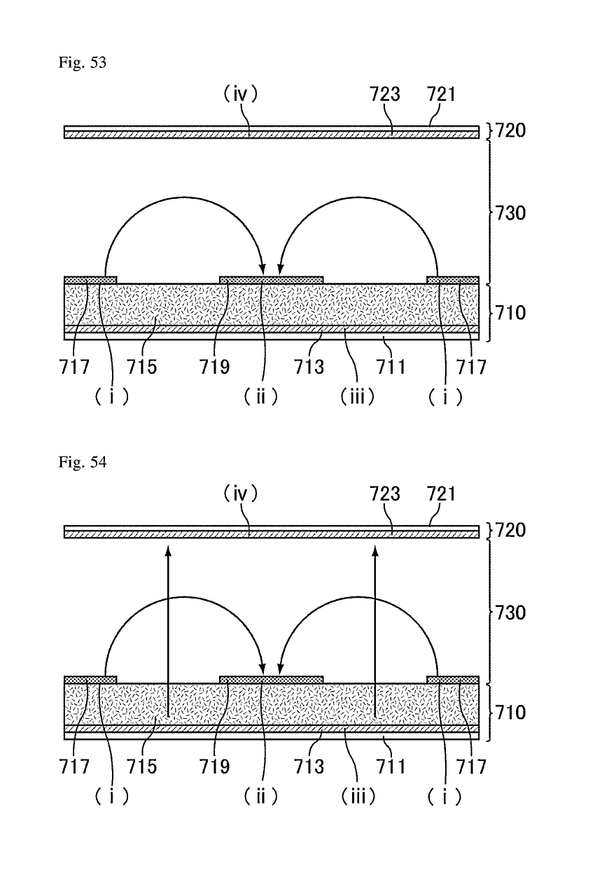

FIG. 53 is a schematic cross-sectional view showing a usual liquid crystal drive device when a displayed image has a low gray scale value. In usual driving, only a transverse electric field is used for driving, and thus the electric field is weak and the response is slow. Usual driving expresses a gray scale on the basis of a balance of the level of the transverse electric field and the viscosity of the liquid crystal.

FIG. 54 is a schematic cross-sectional view showing the liquid crystal drive device of the present invention implementing vertical-electric-field driving when a displayed image has a low gray scale value. In vertical-electric-field driving, the vertical electric field and the transverse electric field are synthesized to provide a higher electric field, resulting in a higher response speed. In this case, an electric field is strong and the liquid crystal is aligned in the electric field direction.

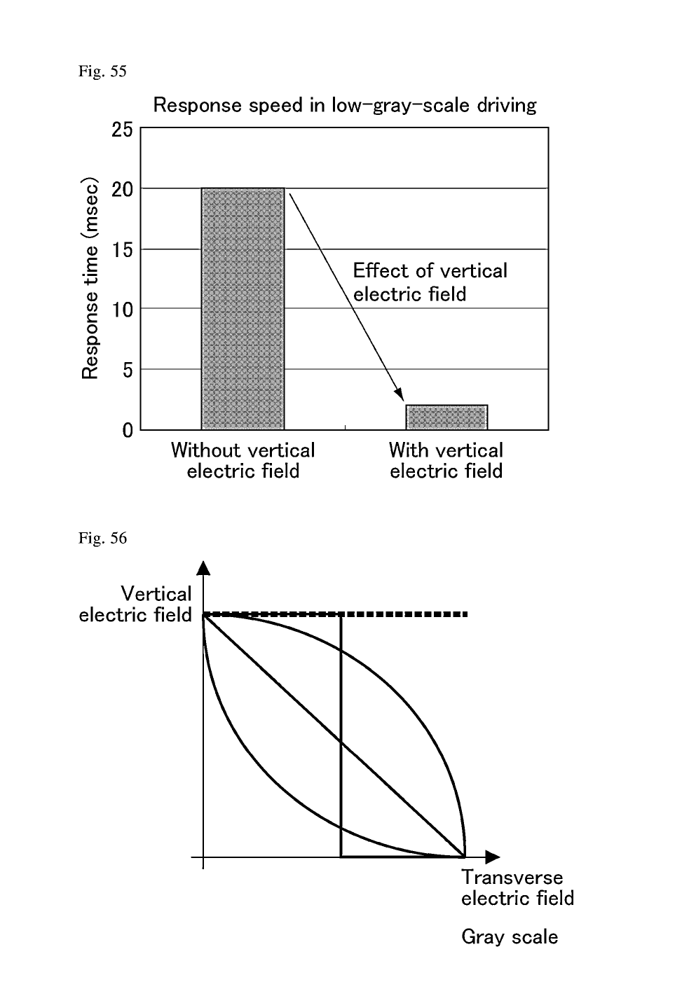

FIG. 55 is a bar graph showing the response speed in low-gray-scale driving. In driving without a vertical electric field, the lower electrode (iii) is at the same electric potential as the counter electrode (iv). In driving with a vertical electric field, a voltage of 7.5 V is applied to the lower electrode (iii).

FIG. 56 is a graph showing the relationship between the vertical electric field and the transverse electric field.

The dot line indicates the example in Embodiment 1 (continuous vertical-electric-field driving). Driving is easily implemented owing to continuous application of a vertical electric field, but the brightness in white display is low. The solid line indicates the example in Embodiment 2 (a vertical electric field is applied only when a displayed image has a low gray scale value). The vertical electric field is removed at a gray scale value of 255, and thus the brightness in white display is high. The vertical electric field is applied as much as possible for a higher response speed.

The aforementioned Embodiments 1 to 4 make the production of a liquid crystal display easy and provide a high transmittance. Further, they are capable of implementing a field sequential mode, and provide a response speed suitable for onboard devices and 3D display devices. The liquid crystal drive device preferably implements field sequential driving and includes a circularly polarizing plate. The liquid crystal drive device has no color filter, and thus field sequential driving causes greater internal reflection. This is because a color filter usually reduces the transmittance to ⅓ of that without a color filter and the reflected light passes the color filter twice, so that the color filter reduces the internal reflection to about 1/10. Subsequently, a circularly polarizing plate sufficiently reduces such internal reflection.

The features of the present invention can be confirmed by decomposing the panel and analyzing the TFT array and the opposite substrate using, for example, an SEM (scanning electron microscope), and investigating its driving voltage.

In the aforementioned embodiments, the electric potential change is inverted for each subframe. The electric potential change is also inverted with respect to the electrodes commonly connected in each even-numbered line and each odd-numbered line. Although the electric potential of the electrode maintained at a certain voltage is described as 7.5 V, this is also substantially referred to as 0 V. Thus, the even-numbered line and the odd-numbered line are driven with reverse polarity.

### Comparative Example 1

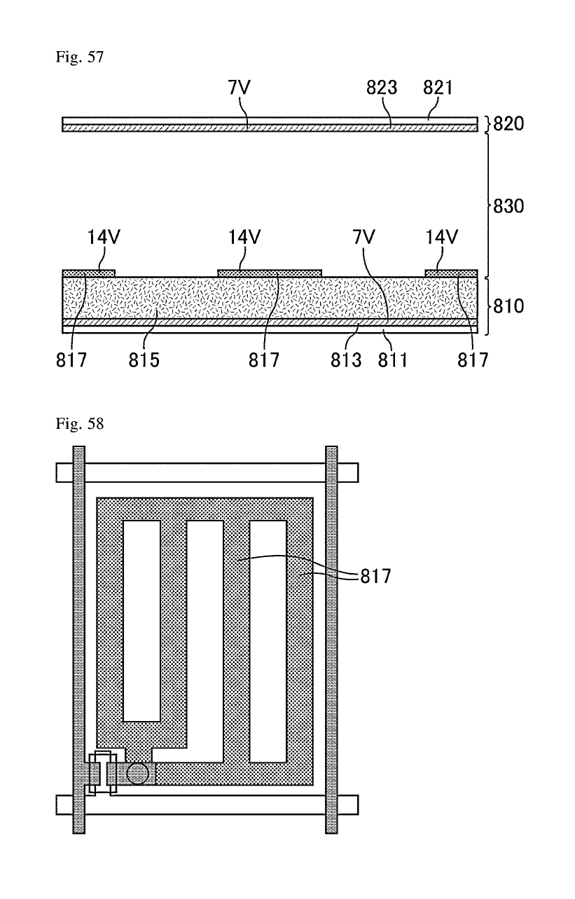

FIG. 57 is a schematic cross-sectional view showing a liquid crystal drive device of Comparative Example 1 in the presence of a fringe electric field. FIG. 58 is a schematic plan view showing the liquid crystal drive device shown in FIG. 57. FIG. 59 shows simulation results relating to the liquid crystal drive device shown in FIG. 57.

The liquid crystal display panel of Comparative Example 1 generates a fringe electric field by FFS driving as in Patent Literature 1. FIG. 59 shows the simulation results (cell thickness: 5.4 μm, slit gap: 2.6 μm) of director D, electric field, and transmittance distribution.

In FIG. 57, the slit electrode 817 is set to 14 V and the opposite planar electrode is set to 7 V. For example, the slit electrode may be set to 5 V and the opposite planar electrode may be set to 0 V. In the FFS driving display (slit electrode is used instead of a pair of comb-shaped electrodes) disclosed in Patent Literature 1, a fringe electric field generated between the upper and lower electrodes on the lower substrate rotates the liquid crystal molecules. In this case, only the liquid crystal molecules near the slit electrode edge rotate. Thus, the transmittance in the simulation was as low as 3.6%. The transmittance was not improved contrary to the aforementioned embodiments (FIG. 59).

### Other Preferable Embodiments

In the embodiments of the present invention, an oxide semiconductor TFT (e.g. IGZO) is preferably used. The following will describe this oxide semiconductor TFT in detail.

At least one of the first substrate and the second substrate usually includes a thin film transistor element. The thin film transistor element preferably includes an oxide semiconductor. In other words, an active layer of an active drive element (TFT) in the thin film transistor element is preferably formed using an oxide semiconductor film such as zinc oxide instead of a silicon semiconductor film. Such a TFT is referred to as an “oxide semiconductor TFT”. The oxide semiconductor characteristically shows a higher carrier mobility and less unevenness in its properties than amorphous silicon. Thus, the oxide semiconductor TFT moves faster than an amorphous silicon TFT, has a high driving frequency, and is suitably used for driving of higher-definition next-generation display devices. In addition, the oxide semiconductor film is formed by an easier process than a polycrystalline silicon film. Thus, it is advantageously applied to devices requiring a large area.

The following characteristics markedly appear in the case of applying the liquid crystal driving method of the present embodiments especially to FSDs (field sequential display devices).

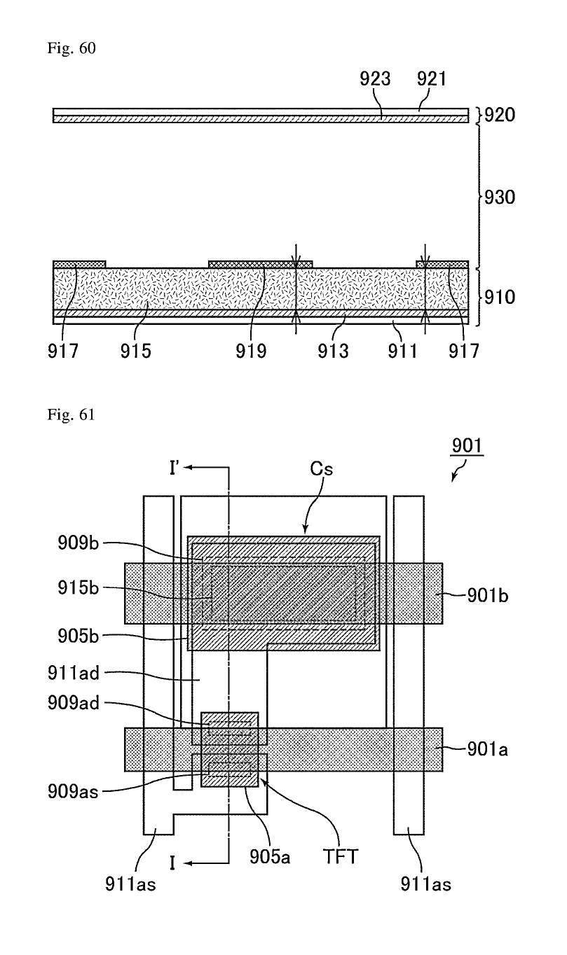

(1) The pixel capacitance is higher than that in a usual VA (vertical alignment) mode (FIG. 60 is a schematic cross-sectional view showing one example of a liquid crystal display device used in the liquid crystal driving method of the present embodiments; in FIG. 60, a large capacitance is generated between the upper electrode and the lower electrode at the portion indicated by an arrow and the pixel capacitance is higher than in the liquid crystal display device of usual vertical alignment (VA) mode).

(2) One pixel of a FSD type is equivalent to three pixels (RGB), and thus the capacitance of one pixel is trebled.

(3) The gate ON time is very short because 240 Hz or higher driving is required.

Advantages of applying the oxide semiconductor TFT (e.g. IGZO) are as follows.

Based on the characteristics (1) and (2), a 52-inch device has a pixel capacitance of about 20 times as high as a 52-inch UV2A 240-Hz drive device.

Thus, a transistor produced using conventional a-Si is as great as about 20 times or more, disadvantageously resulting in an insufficient aperture ratio.

The mobility of IGZO is about 10 times that of a-Si, and thus the size of the transistor is about 1/10.

Although the liquid crystal display device using color filters (RGB) has three transistors, the FSD type device has only one transistor. Thus, the device can be produced in a size as small as or smaller than that with a-Si.

As the size of the transistor becomes smaller, the Cgd capacitance also becomes smaller. This reduces the load on the source bus lines.

### SPECIFIC EXAMPLES

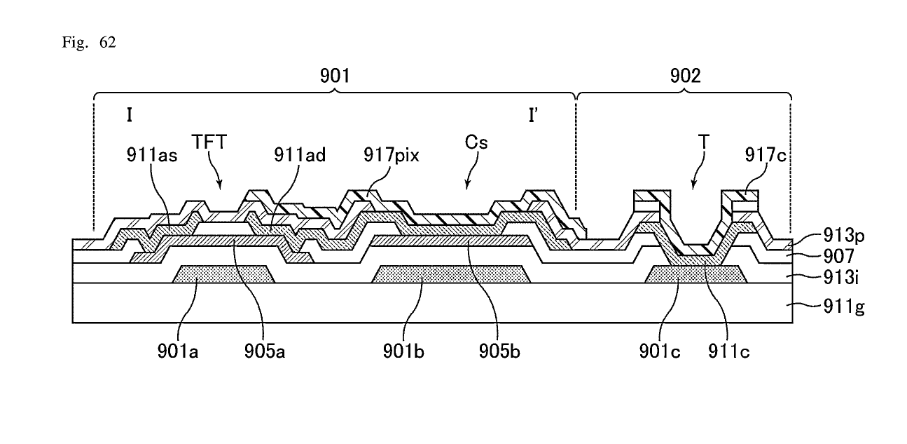

FIG. 61 and FIG. 62 each show a structure (example) of the oxide semiconductor TFT. FIG. 61 is a schematic plan view showing the active drive element and its vicinity used in the present embodiment. FIG. 62 is a schematic cross-sectional view showing an active drive element and its vicinity used in the present embodiment. The symbol T indicates a gate and source terminal. The symbol Cs indicates an auxiliary capacitance.

The following will describe one example (the portion in question) of a production process of the oxide semiconductor TFT.

Active layer oxide semiconductor layers 905a and 905b of an active drive element (TFT) using the oxide semiconductor film are formed as follows.

At first, an In—Ga—Zn—O semiconductor (IGZO) film with a thickness of 30 nm or greater but 300 nm or smaller is formed on an insulating layer 913i by sputtering. Then, a resist mask is formed by photolithography so as to cover predetermined regions of the IGZO film. Next, portions of the IGZO film other than the regions covered by the resist mask are removed by wet etching. Thereafter, the resist mask is peeled off. This provides island-shaped oxide semiconductor layers 905a and 905b. The oxide semiconductor layers 905a and 905b may be formed using other oxide semiconductor films instead of the IGZO film.

Next, an insulating layer 907 is deposited on the whole surface of a substrate 911g and the insulating layer 907 is patterned. Specifically, at first, an SiO₂ film (thickness: about 150 nm, for example) as an insulating layer 907 is formed on the insulating layer 913i and the oxide semiconductor layers 905a and 905b by CVD.

The insulating layer 907 preferably includes an oxide film such as SiOy.

Use of the oxide film can recover oxygen deficiency on the oxide semiconductor layers 905a and 905b by the oxygen in the oxide film, and thus it more effectively suppresses oxygen deficiency on the oxide semiconductor layers 905a and 905b. Here, a single layer of an SiO₂ film is used as the insulating layer 907. Still, the insulating layer 907 may have a stacked structure of an SiO₂ film as a lower layer and an SiNx film as an upper layer.

The thickness (in the case of a stacked structure, the sum of the thicknesses of the layers) of the insulating layer 907 is preferably 50 nm or greater but 200 nm or smaller. The insulating layer with a thickness of 50 nm or greater more securely protects the surfaces of the oxide semiconductor layers 905a and 905b in the step of patterning the source and drain electrodes. If the thickness of the insulating layer exceeds 200 nm, the source electrodes and the drain electrodes may have a higher step, so that breaking of lines may occur.

The oxide semiconductor layers 905a and 905b in the present embodiment are preferably formed from a Zn—O semiconductor (ZnO), an In—Ga—Zn—O semiconductor (IGZO), an In—Zn—O semiconductor (IZO), or a Zn—Ti—O semiconductor (ZTO). Particularly preferred is an In—Ga—Zn—O semiconductor (IGZO).

The present mode provides certain effects in combination with the above oxide semiconductor TFT. Still, the present mode can be driven using a known TFT element such as an amorphous Si TFT or a polycrystalline Si TFT.

The aforementioned modes of the embodiments may be employed in appropriate combination as long as the combination is not beyond the spirit of the present invention.

The present application claims priority to Patent Application No. 2011-142346 filed in Japan on Jun. 27, 2011 under the Paris Convention and provisions of national law in a designated State, the entire contents of which are hereby incorporated by reference.

### REFERENCE SIGNS LIST

10, 110, 210, 310, 410, 510, 610, 710, 810: array substrate
11, 21, 111, 121, 211, 221, 311, 321, 411, 421, 511, 521, 611, 621, 711, 721, 811, 821: glass substrate
13, 23, 113, 123, 213, 223, 313, 323, 413, 423, 513, 523, 613, 623, 713, 723, 813, 823: counter electrode
15, 115, 215, 315, 415, 515, 615, 715, 815: insulating layer
16: pair of comb-shaped electrodes
17, 19, 117, 119, 217, 219, 417, 419, 517, 519, 617, 619, 717, 719: comb-shaped electrode
20, 120, 220, 320, 420, 520, 620, 720, 820: opposed substrate
30, 130, 230, 330, 430, 530, 630, 730, 830: liquid crystal layer
31: liquid crystal (liquid crystal molecules)
41: timing of 0.6 ms
817: slit electrode
901a: gate line
901b: auxiliary capacitance line
901c: connection portion
911g: substrate
913i: insulating layer (gate insulator)
905a, 905b: oxide semiconductor layer (active layer)
907: insulating layer (etching stopper, protection film)
909as, 909ad, 909b, 915b: opening
911as: source line
911ad: drain line
911c, 917c: connection portion
913p: protection film
917pix: pixel electrode
901: pixel portion
902: terminal-located region
Cs: auxiliary capacitance
T: gate and source terminal
D: director
t: transmittance

1. A liquid crystal drive device, comprising:
a first substrate;
a second substrate;
a liquid crystal layer disposed between the substrates; and
at least two pairs of electrodes including a first electrode pair and a second electrode pair that is different from the first electrode pair, the at least two pairs of electrodes driving a liquid crystal,
the liquid crystal drive device being configured to implement a driving operation that generates a potential difference between electrodes of the first electrode pair and simultaneously generates a potential difference between electrodes of the second electrode pair when a displayed image has a gray scale value that is half or smaller of the total number of gray scale values for image display.

2. The liquid crystal drive device according to claim 1,
which is configured to implement a driving operation that generates a potential difference between the electrodes of the first electrode pair and simultaneously generates a potential difference between the electrodes of the second electrode pair when a displayed image has a gray scale value that is greater than half of the total number of gray scale values for image display.

3. The liquid crystal drive device according to claim 1,
which is configured to implement a driving operation that generates a potential difference between the electrodes of the first electrode pair but simultaneously generates no potential difference between the electrodes of the second electrode pair when a displayed image has a gray scale value that is greater than half of the total number of gray scale values for image display.

4. The liquid crystal drive device according to claim 1,
which changes an electric potential of one electrode of the second electrode pair during image display.

5. A liquid crystal drive device, comprising:
a first substrate;
a second substrate;
a liquid crystal layer disposed between the substrates; and
at least two pairs of electrodes including a first electrode pair and a second electrode pair that is different from the first electrode pair, the at least two pairs of electrodes driving a liquid crystal,
the liquid crystal drive device being configured to implement a driving operation that generates no potential difference between electrodes of the first electrode pair but generates a potential difference between each electrode of the first electrode pair and one electrode of the second electrode pair, and simultaneously generates a potential difference between electrodes of the second electrode pair when a displayed image has a gray scale value that is half or smaller of the total number of gray scale values for image display.

6. The liquid crystal drive device according to claim 1,
wherein the first electrode pair is a pair of comb-shaped electrodes disposed on the second substrate, and
the second electrode pair is a pair of counter electrodes disposed on the respective first and second substrates.

7. The liquid crystal drive device according to claim 1,
which is to be used in a field sequential driving display device, an onboard display device, or a 3D display device.

8. The liquid crystal drive device according to claim 1, further comprising multiple pixels for image display,
wherein electrodes each of which corresponds to one of the first electrode pair and/or electrodes each of which corresponds to the other of the first electrode pair are electrically connected along a pixel line.

9. The liquid crystal drive device according to claim 8,
wherein the electrodes each of which corresponds to one of the first electrode pair and/or the electrodes each of which corresponds to the other of the first electrode pair comprise a transparent conductor and a metal conductor that is electrically connected to the transparent conductor.

10. The liquid crystal drive device according to claim 1,
wherein at least one electrode of the first electrode pair is electrically connected to one of the second electrode pair.

11. The liquid crystal drive device according to claim 1, further comprising multiple pixels for image display,
wherein electrodes each of which corresponds to one of the second electrode pair and/or electrodes each of which corresponds to the other of the second electrode pair are electrically connected along a pixel line.

12. The liquid crystal drive device according to claim 11,
wherein the electrodes each of which corresponds to one of the second electrode pair and/or the electrodes each of which corresponds to the other of the second electrode pair comprise a transparent conductor and a metal conductor that is electrically connected to the transparent conductor.

13. The liquid crystal drive device according to claim 1, further comprising a metal line,
wherein main lines of the electrodes electrically connected in each pixel line overlap the metal line in a plan view of main surfaces of the substrates.

14. The liquid crystal drive device according to claim 1,
which is configured to implement field sequential driving and which further comprises a circularly polarizing plate.

15. The liquid crystal drive device according to claim 1,
wherein at least one of the first substrate and the second substrate comprises a thin film transistor element, and
the thin film transistor element comprises an oxide semiconductor.

16. A liquid crystal display device, comprising the liquid crystal drive device according to claim 1.

17. A liquid crystal display device, comprising the liquid crystal drive device according to claim 5.
